(19) United States
(12) Patent Application Publication
(10) Pub. No.: US 2026/0269872 A1
(43) Pub. Date: Sep. 10, 2026

(54) COMMUNICATION SYSTEM, COMMUNICATION METHOD, AND RECORDING MEDIUM

(71) Applicant: NEC Corporation, Minato-ku, Tokyo (CN)

(72) Inventors: Kohei Yoshida, Tokyo (JP); Koya Takata, Tokyo (JP); Kenji Wakafuji, Tokyo (JE); Ryota Nihei, Tokyo (JP); Fujio Okumura, Kanagawa (JP)

(73) Assignee: NEC Corporation, Minato-ku, Tokyo (JP)

(21) Appl. No.: 18/724,712

(22) PCT Filed: Feb. 10, 2022
(86) PCT No.: PCT/JP2022/005285

§ 371 Date: Jun. 27, 2024

(51) Int. Cl. H04B 7/04; H01Q 19/10; H01Q 21/00; H04B 7/06; H04B 10/60; H04B 10/80

(52) U.S. Cl. CPC H04B 7/04013; H01Q 19/10; H01Q 21/00; H04B 7/0617; H04B 10/60; H04B 10/807; H04B 2210/006

(57) ABSTRACT

A communication system that includes a communication device including a phased array antenna that transmits a beamformed radio wave and a first optical communication machine associated with the phased array antenna, and a reflection device including a radio wave reflective plate having a reflection surface of a meta-surface structure and a second optical communication machine associated with the radio wave reflective plate. The second optical communication machine retroreflects, toward the first optical communication machine, reflected light of projection light modulated in a pattern related to transmission data that includes direction data and device data related to the radio wave reflective plate. The first optical communication machine acquires the transmission data related to the radio wave reflective plate according to the pattern of the reflected light from the second optical communication machine, and controls the phased array antenna according to the acquired transmission data.

### TECHNICAL FIELD

The present disclosure relates to a communication system and the like used for mobile communication.

### BACKGROUND ART

In mobile communication after the fifth generation mobile communication (5G), radio waves in a high frequency band are used as compared with previous mobile communication. The radio wave in such a high frequency band has higher straightness and is easily attenuated than before. In next-generation mobile communication, a situation may occur in which a radio wave transmitted from a base station hardly reaches a receiver due to a factor such as an obstacle. Therefore, a technique for efficiently causing radio waves in a high frequency band to reach an antenna of a receiver is demanded.

PTL 1 discloses a phased array antenna device having an array antenna including a plurality of antenna elements. The plurality of antenna elements included in the device of PTL 1 is disposed in a two-dimensional array.

PTL 2 discloses an optical modulation system using a metamaterial structure. In the metamaterial structure of PTL 2, a state of transmission/non-transmission with respect to an optical signal of an operating wavelength changes in response to stimulation by a stimulation source. The metamaterial structure of PTL 2 is disposed on a first reflection surface of a retroreflector that receives an input optical signal.

### CITATION LIST

### Patent Literature

PTL 1: JP 6721226 B1

PTL 2: JP 2012-003265 A

### SUMMARY OF INVENTION

### Technical Problem

By using the device of PTL 1, the configuration of the antenna unit including the plurality of antenna elements can be changed to communicate with the plurality of communication targets. However, radio waves in a high frequency band used in next-generation mobile communication are blocked by an obstacle interposed between the device of PTL 1 and a communication target. Therefore, in the method of PTL 1, communication cannot be performed when an obstacle is interposed between the device of PTL 1 and a communication target.

By using the metamaterial structure of PTL 2, a reconfigurable intelligent surface (RIS) reflective plate can be configured. By combining a plurality of RIS reflective plates, an obstacle between the communication devices can be avoided, and coverage of wireless communication can be expanded. For this purpose, it is necessary to arrange a large number of RIS reflective plates in accordance with a situation in which a plurality of communication terminals move. In some cases, the RIS reflective plate is required to be placed in an environment where power supply is difficult. In such an environment, since it is difficult to supply power, it is required to arrange the RIS reflective plate with as low power consumption as possible.

The transmission source of the radio wave can transmit the radio wave in a desired direction by accurately grasping the position of the RIS reflective plate, the direction in which the reflection surface of the RIS reflective plate faces, and the characteristics set for the RIS reflective plate. For example, by using the RIS reflective plate including the material structure of PTL 2, the material structure is controlled in such a way that the radio wave arriving at the reflection surface of the RIS reflective plate is retroreflected to the transmission source of the radio wave, whereby the information about the RIS reflective plate can be transmitted to the transmission source. To accommodate a plurality of transmission sources, power is required to control the material structure for each transmission source. However, it is difficult to supply power for controlling the material structure for each transmission source to the RIS reflective plate disposed in an environment where power supply is difficult.

An object of the present disclosure is to provide a communication system and the like capable of continuously communicating with a desired communication target even in an environment where power supply is difficult.

### Solution to Problem

A communication system according to an aspect of the present disclosure includes a communication device including a phased array antenna that transmits a beamformed radio wave and a first optical communication machine associated with the phased array antenna, and a reflection device including a radio wave reflective plate having a reflection surface of a meta-surface structure and a second optical communication machine associated with the radio wave reflective plate. The first optical communication machine projects projection light toward the second optical communication machine associated with the radio wave reflective plate. The second optical communication machine is activated in response to receiving light of the projection light projected by the first optical communication machine, generates direction data related to the direction from which the projection light arrived, and retroreflects, toward the first optical communication machine, reflected light of projection light modulated in a pattern related to transmission data that includes direction data and device data related to the radio wave reflective plate. The first optical communication machine acquires the transmission data related to the radio wave reflective plate according to the pattern of the reflected light from the second optical communication machine, and controls the phased array antenna according to the acquired transmission data.

A communication method according to an aspect of the present disclosure is a communication method in a communication system including a phased array antenna that transmits a beamformed radio wave and a radio wave reflective plate having a reflection surface of a meta-surface structure, the communication method including causing a first optical communication machine associated with the phased array antenna to project projection light toward a second optical communication machine associated with the radio wave reflective plate, causing the second optical communication machine that is activated in response to receiving the projection light projected from the first optical communication machine to generate direction data in response to detecting a direction from which the projection light arrives, causing the second optical communication machine to retroreflect reflected light of the projection light modulated in a pattern according to transmission data including device data related to the radio wave reflective plate and the direction data toward the first optical communication machine, causing the first optical communication machine to acquire the transmission data related to the radio wave reflective plate according to a pattern of the reflected light from the second optical communication machine, and causing the first optical communication machine to control the phased array antenna according to the device data acquired by the first optical communication machine.

A program according to an aspect of the present disclosure is a program for operating a communication system including a phased array antenna that transmits a beamformed radio wave and a radio wave reflective plate having a reflection surface of a meta-surface structure, the program causing a computer to execute the steps of causing a first optical communication machine associated with the phased array antenna to project projection light toward a second optical communication machine associated with the radio wave reflective plate, causing the second optical communication machine that is activated in response to receiving the projection light projected from the first optical communication machine to generate direction data in response to detecting a direction from which the projection light arrives, causing the second optical communication machine to retroreflect reflected light of the projection light modulated in a pattern according to transmission data including device data related to the radio wave reflective plate and the direction data toward the first optical communication machine, causing the first optical communication machine to acquire the transmission data related to the radio wave reflective plate according to a pattern of the reflected light from the second optical communication machine, and causing the first optical communication machine to control the phased array antenna according to the device data acquired by the first optical communication machine.

### Advantageous Effects of Invention

According to the present disclosure, it is possible to provide a communication system and the like capable of continuously communicating with a desired communication target even in an environment where power supply is difficult.

### BRIEF DESCRIPTION OF DRAWINGS

FIG. 1 is a block diagram illustrating an example of a configuration of a communication system according to a first example embodiment.

FIG. 2 is a conceptual diagram illustrating an arrangement example of a communication device and a reflection device included in the communication system according to the first example embodiment.

FIG. 3 is a block diagram illustrating an example of a configuration of a communication device included in the communication system according to the first example embodiment.

FIG. 4 is a block diagram illustrating an example of a configuration of a projector included in a first optical communication machine of a communication device included in the communication system according to the first example embodiment.

FIG. 5 is a block diagram illustrating an example of a configuration of a light receiver included in the first optical communication machine of the communication device included in the communication system according to the first example embodiment.

FIG. 6 is a conceptual diagram illustrating an example of a configuration of a second optical communication machine included in a reflection device included in the communication system according to the first example embodiment.

FIG. 7 is a conceptual diagram illustrating an example of a configuration of a photovoltaic generator included in the second optical communication machine of the reflection device included in the communication system according to the first example embodiment.

FIG. 8 is a conceptual diagram illustrating an example of a configuration of a direction sensor included in the second optical communication machine of the reflection device included in the communication system according to the first example embodiment.

FIG. 9 is a conceptual diagram illustrating an example of a configuration of a reflector included in the second optical communication machine of the reflection device included in the communication system according to the first example embodiment. FIG. 10 is a conceptual diagram illustrating an example of a configuration of the reflector included in the second optical communication machine of the reflection device included in the communication system according to the first example embodiment.

FIG. 11 is a conceptual diagram illustrating a configuration example of the second optical communication machine of the reflection device included in the communication system according to the first example embodiment.

FIG. 12 is a conceptual diagram illustrating an example of communication light exchange between the first optical communication machine and the second optical communication machine included in the communication system according to the first example embodiment.

FIG. 13 is a conceptual diagram illustrating an example of a state in which projection light projected from the first optical communication machine included in the communication system according to the first example embodiment is received by the second optical communication machine.

FIG. 14 is a conceptual diagram illustrating an example of a state in which reflected light reflected by the second optical communication machine included in the communication system according to the first example embodiment is received by the first optical communication machine.

FIG. 15 is a conceptual diagram illustrating an example of a state in which a radio wave transmitted from a phased array antenna included in the communication system according to the first example embodiment is received by the reflection device.

FIG. 16 is a flowchart for describing an example of the operation of the communication device included in the communication system according to the first example embodiment.

FIG. 17 is a flowchart for describing an example of the operation of the second optical communication machine included in the reflection device included in the communication system according to the first example embodiment.

FIG. 18 is a block diagram illustrating an example of a configuration of a communication system according to a second example embodiment.

FIG. 19 is a conceptual diagram illustrating an arrangement example of a communication device and a reflection device included in the communication system according to the second example embodiment.

FIG. 20 is a conceptual diagram illustrating an example of a configuration of a second optical communication machine included in the communication device of the communication system according to the second example embodiment.

FIG. 21 is a flowchart for describing an example of the operation of the communication device included in the communication system according to the second example embodiment.

FIG. 22 is a flowchart for describing an example of a communication process by the communication device included in the communication system according to the first example embodiment.

FIG. 23 is a flowchart for describing an example of an operation of a second optical communication machine included in a reflection device included in a communication system according to a second example embodiment.

FIG. 24 is a flowchart for describing an example of a scan process by the second optical communication machine included in a reflection device included in the communication system according to the second example embodiment.

FIG. 25 is a conceptual diagram for describing Application Example 1 of the communication system according to the second example embodiment.

FIG. 26 is a conceptual diagram for describing Application Example 2 of the communication system according to the second example embodiment.

FIG. 27 is a conceptual diagram for describing Application Example 3 of the communication system according to the second example embodiment.

FIG. 28 is a block diagram illustrating an example of a configuration of a communication system according to a third example embodiment.

FIG. 29 is a block diagram illustrating an example of a hardware configuration that implements control and a process of each example embodiment.

### EXAMPLE EMBODIMENT

Hereinafter, example embodiments of the present invention will be described with reference to the drawings. However, the example embodiments described below have technically preferable limitations for carrying out the present invention, but the scope of the present invention is not limited to the following. In all the drawings used in the following description of the example embodiment, the same reference numerals are given to the same parts unless there is a particular reason. In the following example embodiments, repeated description of similar configurations and operations may be omitted.

In the following example embodiments, components included in a system will be described with reference to conceptual diagrams. The conceptual diagrams used in the following description of the example embodiments do not accurately illustrate the shape, size, positional relationship, and the like of the components included in the system.

### First Example Embodiment

First, a communication system according to a first example embodiment will be described with reference to the drawings. The communication system of the present example embodiment includes a reconfigurable intelligent surface (RIS) reflective plate. The RIS reflective plate has a reflection surface including a meta-surface structure capable of controlling a reflection direction of a radio wave. The communication system in the present example embodiment includes a passive RIS reflective plate.

### Configuration

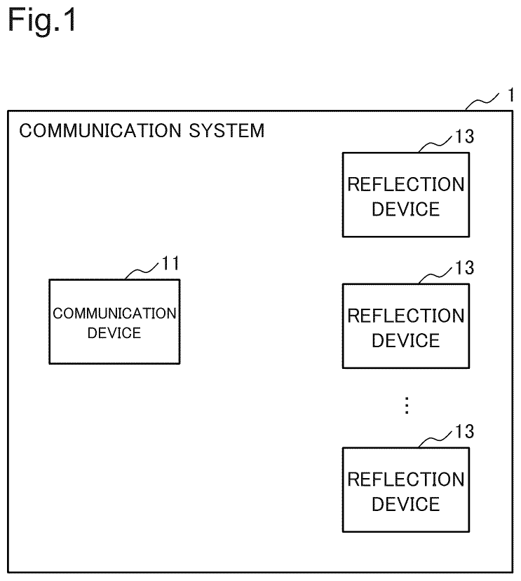

FIG. 1 is a block diagram illustrating an example of a configuration of a communication system 1 according to the present example embodiment. The communication system 1 includes a communication device 11 and a reflection device 13. In the present example embodiment, an example in which the communication system 1 is configured by a single communication device 11 and a plurality of reflection devices 13 will be described. The communication system 1 may include a plurality of communication devices 11. The communication system 1 may include at least one reflection device 13. The communication system 1 may be configured by a single reflection device 13.

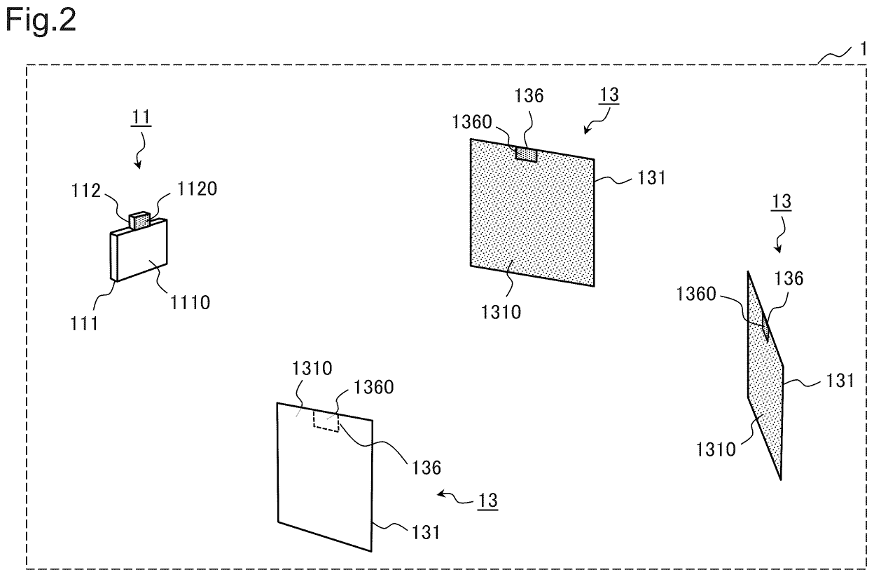

FIG. 2 is a conceptual diagram illustrating an example of a positional relationship between the communication device 11 and the reflection device 13. The communication device 11 includes a phased array antenna 111 and a first optical communication machine 112. The reflection device 13 includes a radio wave reflective plate 131 and a second optical communication machine 136.

Phased array antenna 111 includes a transmission/reception face 1110 used for transmission and reception of radio waves. A plurality of antenna elements is regularly disposed on the transmission/reception face 1110. For example, a plurality of antenna elements is disposed in a lattice pattern on the transmission/reception face 1110. Each of the plurality of antenna elements includes a phase shifter (not illustrated) that changes a phase of a radio wave to be transmitted and received. The phase of the radio wave transmitted and received by each antenna element is controlled using a phase shifter. By controlling the phases of the plurality of antenna elements, the radio wave transmitted from phased array antenna 111 can be beamformed. As long as the radio wave can be beamformed, the arrangement of the plurality of antenna elements is not limited. Radio waves transmitted and received using the phased array antenna 111 and information included in the radio waves are not limited. For example, the phased array antenna 111 transmits and receives radio waves in a frequency band used in mobile communication such as fifth generation mobile communication (5G) and sixth generation mobile communication (6G). Phased array antenna 111 may be configured to be able to transmit and receive radio waves in a frequency band used in mobile communication after the seventh generation mobile communication (7G).

For example, the plurality of antenna elements disposed on the transmission/reception face 1110 of the phased array antenna 111 is divided into a plurality of antenna units of 2×2 units (4 divisions) or 4×4 units (16 divisions). The plurality of antenna elements disposed on the transmission/reception face 1110 constitutes a phased array for each antenna unit. Phased array antenna 111 is allocated to communication with a single communication target for each antenna unit. For example, the plurality of antenna elements is disposed in a 16×16 (256 ) lattice pattern on the transmission/reception face 1110, and the antenna units are allocated in 2×2 (4 divisions). In this case, 64 channels are formed in phased array antenna 111. For example, the plurality of antenna elements is disposed in a 16×16 (256 ) lattice pattern on the transmission/reception face 1110, and the antenna units are allocated in 4×4 (16 divisions). In this case, 16 channels are formed in phased array antenna 111. The number of channels formed in phased array antenna 111 is not limited to this example, and can be set in any manner according to the combination of the antenna elements disposed on the transmission/reception face 1110.

The first optical communication machine 112 includes a light transmitting/receiving face 1120 for transmitting and receiving optical signals. The light transmitting/receiving face 1120 is directed to the reflection device 13. The transmission/reception face 1110 of the phased array antenna 111 and the light transmitting/receiving face 1120 of the first optical communication machine 112 are directed in the same direction. The first optical communication machine 112 projects projection light from the light transmitting/receiving face 1120 to the second optical communication machine 136 of the reflection device 13. For example, the first optical communication machine 112 projects laser light modulated at a constant cycle. The projection light projected from the first optical communication machine 112 serves as a power supply source to the solar cell that operates the second optical communication machine 136 of the reflection device 13.

The first optical communication machine 112 receives the reflected light reflected by the second optical communication machine 136 of the reflection device 13. The reflected light includes information about the reflection device 13 that is a reflection source. The first optical communication machine 112 acquires information about the reflection device 13 that is the reflection source of the reflected light in response to the received reflected light. The first optical communication machine 112 controls the phased array antenna 111 according to the information about the reflection device 13. As a result, a radio wave toward a communication target (not illustrated) is transmitted from phased array antenna 111 toward the reflection device 13.

The radio wave reflective plate 131 is a passive RIS reflective plate. The radio wave reflective plate 131 has a reflection surface 1310. A meta-surface structure is formed on the reflection surface 1310. The meta-surface structure includes a structure in which elements capable of electrically switching phases are disposed in a lattice pattern. By controlling the elements disposed on the reflection surface 1310, the reflection direction of the radio wave can be controlled. The reflection device 13 is disposed in such a way that the communication device 11 and a communication target (not illustrated) can perform wireless communication via the reflection surface 1310 of the reflection device 13. In the present example embodiment, the communication target of the communication device 11 is not limited. Therefore, the plurality of reflection devices 13 is disposed in various directions in such a way that the communication range of the communication device 11 is wider.

The second optical communication machine 136 includes a light transmitting/receiving face 1360 for transmitting and receiving optical signals. The reflection surface 1310 of the radio wave reflective plate 131 and the light transmitting/receiving face 1360 of the second optical communication machine 136 are directed in the same direction. The second optical communication machine 136 receives projection light projected from the first optical communication machine 112 of the communication device 11 on the light transmitting/receiving face 1360. The second optical communication machine 136 includes a solar cell (not illustrated). The solar cell generates power in response to receiving projection light. The second optical communication machine 136 is activated by the power supply related to the power generation of the solar cell. The activated second optical communication machine 136 detects the direction from which the projection light arrives. The second optical communication machine 136 includes a retroreflective plate (not illustrated). A shutter (not illustrated) that opens and closes according to electrical control is installed in front of the reflection surface of the retroreflective plate. The second optical communication machine 136 controls opening and closing of the shutter according to the opening and closing condition stored in advance. The opening and closing condition stored in advance corresponds to a pattern for transmitting information about the reflection device 13. The reflected light modulated according to the opening/closing pattern of the shutter is emitted from the second optical communication machine 136 by opening/closing control of the shutter by the second optical communication machine 136. The reflected light emitted from the second optical communication machine 136 travels toward the first optical communication machine 112 that is the projection source of the projection light. The reflected light is received by the first optical communication machine 112.

The above is a schematic description of the communication system 1. Next, detailed configurations of the communication device 11 and the reflection device 13 which are components of the communication system 1 will be described with reference to the drawings.

### Communication Device

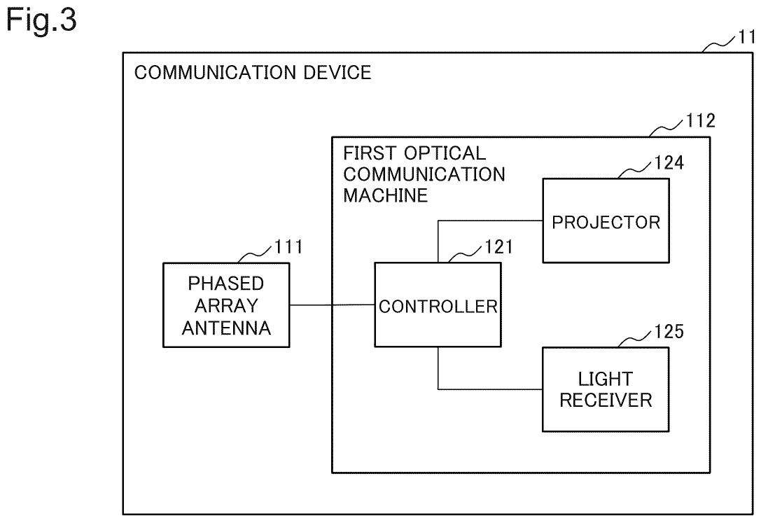

FIG. 3 is a block diagram illustrating an example of a configuration of the communication device 11. The first optical communication machine 112 includes a controller 121, a projector 124, and a light receiver 125. The phased array antenna 111 is connected to the controller 121 of the first optical communication machine 112. Phased array antenna 111 operates under the control of the controller 121.

The controller 121 causes the projector 124 to emit projection light from the projector 124. For example, the controller 121 causes projector 124 to emit projection light (also referred to as search light) used for searching for the reflection device 13. The controller 121 causes the projector 124 to emit the search light modulated at a constant frequency.

When the light receiver 125 receives the reflected light from any of the reflection devices 13, the controller 121 controls the phased array antenna 111 and the projector 124. For example, the controller 121 identifies information such as the position and the direction of the reflection device 13 according to the information included in the reflected light. The information included in the reflected light includes information (also referred to as device data) regarding the reflection device 13 and a direction (also referred to as direction data) of the communication device 11 with respect to the reflection device 13. The device data includes the specification of the reflection device 13 and a state of the reflection surface 1310 of the reflection device 13. The controller 121 recognizes the specification and the state of the reflection surface 1310 of the reflection device 13 according to the device data. The direction data indicates the direction of the reflection surface 1310 of the reflection device 13. The controller 121 recognizes the direction of the reflection surface 1310 of the reflection device 13 according to the direction data.

The controller 121 selects antenna elements disposed on the transmission/reception face 1110 of phased array antenna 111 in order to transmit a radio wave having directivity toward the reflection surface 1310 of the reflection device 13. The controller 121 configures an antenna unit with the plurality of selected antenna elements. The antenna unit constitutes a phased array. The controller 121 causes each of the plurality of antenna elements constituting the antenna unit to transmit a radio wave having directivity toward the reflection device 13. For example, the controller 121 shifts the phase of the radio wave transmitted from the plurality of antenna elements according to a preset transmission condition of the radio wave. The controller 121 shifts the phases of the radio waves transmitted from the plurality of antenna elements to direct the transmission direction of the radio waves toward the reflection device 13.

For example, the controller 121 is implemented by a microcomputer or a microcontroller. For example, the controller 121 includes a central processing unit (CPU), a random access memory (RAM), a read only memory (ROM), a flash memory, and the like. For example, the controller 121 stores data related to a light projection condition by the projector 124 and the reflected light received by the light receiver 125 in the flash memory.

The projector 124 projects projection light under the control of the controller 121. For example, the projector 124 emits laser light having directivity. In the present example embodiment, an example in which the projector 124 emits laser light will be described. The wavelength band of the projection light projected by the projector 124 is not limited. The wavelength band of the projection light projected by the projector 124 may match the wavelength band of the light receiving target by the second optical communication machine 136 of the reflection device 13. The projector 124 preferably has a mechanism capable of scanning with projection light in order to search for a reflection device 23 whose position is not identified. In the present example embodiment, an example in which the projector 124 includes a phase modulation type spatial light modulator will be described.

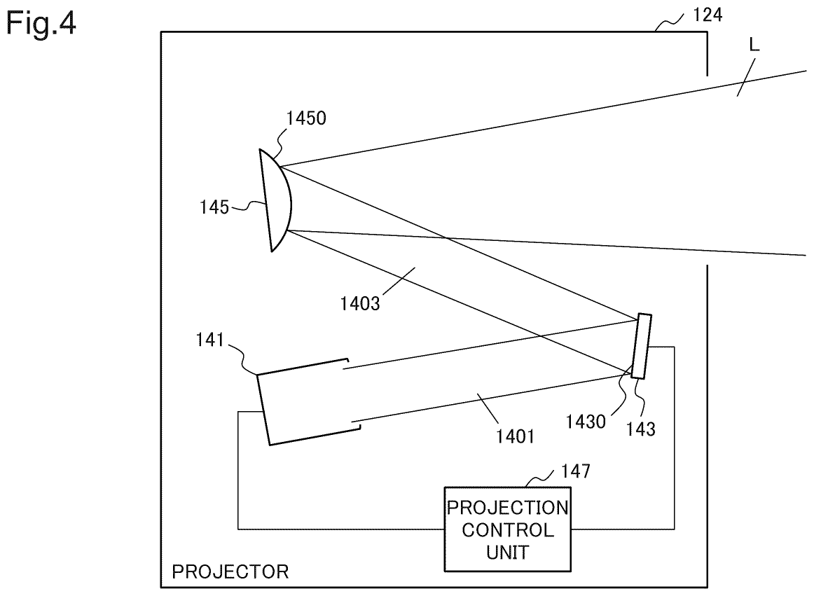

FIG. 4 is a conceptual diagram illustrating an example of a configuration of the projector 124. The projector 124 includes a light source 141, a spatial light modulator 143, a curved face mirror 145, and a projection control unit 147. FIG. 4 is a side view of the internal configuration of the projector 124 when viewed from the lateral direction. FIG. 4 is conceptual, and does not accurately represent the size and positional relationship of each component, the traveling direction of light, and the like.

The light source 141 emits laser light in a predetermined wavelength band under the control by the projection control unit 147. The wavelength of the laser light emitted from the light source 141 is not particularly limited, and may be selected according to the application. For example, the light source 141 emits laser light in a wavelength band in the visible region. For example, the light source 141 emits laser light in a wavelength band of an infrared region. The wavelength band in the infrared region is referred to as an infrared ray. For example, in the case of near infrared rays of 800 to 900 nanometers (nm), the laser class can be increased, in such a way that the sensitivity can be improved by about one digit as compared with other wavelength bands. For example, a high-output laser light source can be used for infrared rays in a wavelength band of 1.55 micrometers (μm). An aluminum gallium arsenide phosphorus (AlGaAsP)-based laser light source can be used as an infrared laser light source in the 1.55 μm band. An indium gallium arsenide (InGaAs)-based laser light source can be used as an infrared laser light source in the 1.55 μm band. The longer the wavelength of the laser light is, the larger the diffraction angle can be made and the higher the energy can be set.

The light source 141 includes a lens (not illustrated) that enlarges the laser light in accordance with the size of the modulation region set in a modulation part 1430 of the spatial light modulator 143. The light source 141 emits light 1401 enlarged by the lens. The light 1401 emitted from the light source 141 travels toward the modulation part 1430 of the spatial light modulator 143.

The spatial light modulator 143 includes the modulation part 1430. The modulation part 1430 of the spatial light modulator 143 is irradiated with light 1401 emitted from the light source 141. A modulation region is set in the modulation part 1430 of the spatial light modulator 143. In the modulation region of the modulation part 1430, a pattern (also referred to as a phase image) related to the image displayed by projection light L is set according to the control by the projection control unit 147. The light 1401 incident on the modulation part 1430 of the spatial light modulator 143 is modulated according to the pattern set in the modulation part 1430 of the spatial light modulator 143. The modulated light 1403 modulated by the modulation part 1430 of the spatial light modulator 143 travels toward a reflection surface 1450 of the curved face mirror 145.

For example, the spatial light modulator 143 is achieved by a spatial light modulator using ferroelectric liquid crystal, homogeneous liquid crystal, vertical alignment liquid crystal, or the like. For example, the spatial light modulator 143 can be achieved by liquid crystal on silicon (LCOS). The spatial light modulator 143 may be achieved by a micro electro mechanical system (MEMS). The phase modulation type spatial light modulator 143 is operated to sequentially switch the place where the projection light L is projected, thereby switching the projection direction of the projection light L. The phase modulation type spatial light modulator 143 can concentrate energy on a portion of an image. Therefore, in the case of using the phase modulation type spatial light modulator 143, when the output of the light source 141 is the same, the image can be displayed brighter than that of other methods.

The modulation region of the modulation part 1430 of the spatial light modulator 143 is divided into a plurality of regions (also referred to as tiling). For example, the modulation region of the modulation part 1430 is divided into rectangular regions (also referred to as tiles) having a desired aspect ratio. A phase image is allocated to each of the plurality of tiles. Each of the plurality of tiles includes a plurality of pixels. A phase image related to a projected image is set to each of the plurality of tiles. The phase images set to the plurality of tiles may be the same or different. When the different reflection devices 13 are allocated to respective tiles, projection light can be simultaneously projected toward different reflection devices 13.

A phase image is tiled to each of the plurality of tiles allocated to the modulation region of the modulation part 1430. For example, a phase image generated in advance is set in each of the plurality of tiles. When the modulation part 1430 is irradiated with the light 1401 in a state where the phase images are set for the plurality of tiles, modulated light 1403 that forms an image related to the phase image of each tile is emitted. As the number of tiles set in the modulation part 1430 increases, a clear image can be displayed. However, when the number of pixels of each tile decreases, the resolution decreases. Therefore, the size and the number of tiles set in the modulation region of the modulation part 1430 are set according to the required image definition, resolution, and the like.

The curved face mirror 145 is a reflecting mirror having the curved reflection surface 1450. The reflection surface 1450 of the curved face mirror 145 has a curvature related to the projection angle of the projection light L. The reflection surface 1450 of the curved face mirror 145 may be a curved face. For example, a reflection surface 1450 of the curved face mirror 145 is a spherical face. For example, the reflection surface 1450 of the curved face mirror 145 may be a cylindrical surface. For example, the reflection surface 1450 of the curved face mirror 145 may be a free-form surface. For example, the reflection surface 1450 of the curved face mirror 145 may have a shape in which a plurality of curved faces is combined instead of a single curved face. For example, the reflection surface 1450 of the curved face mirror 145 may have a shape in which a curved face and a flat face are combined.

The curved face mirror 145 is disposed on an optical path of the modulated light 1403. The reflection surface 1450 of the curved face mirror 145 is directed to the modulation part 1430 of the spatial light modulator 143. The reflection surface 1450 of the curved face mirror 145 is irradiated with the modulated light 1403 modulated by the modulation part 1430 of the spatial light modulator 143. The light (projection light L) reflected by the reflection surface 1450 of the curved face mirror 145 is enlarged and projected at an enlargement ratio in accordance with the curvature of the reflection surface 1450.

For example, a shield (not illustrated) may be disposed between the spatial light modulator 143 and the curved face mirror 145. In other words, the shield may be disposed on an optical path of the modulated light 1403 modulated by the modulation part 1430 of the spatial light modulator 143. The shield is a frame that shields unnecessary light components included in the modulated light 1403 and defines an outer edge of a display region of the projection light L. For example, the shield is an aperture in which a slit-shaped opening is formed in a portion that transmits light forming a desired image. The shield transmits light that forms a desired image and shields unwanted light components. For example, the shield shields zero order light or a ghost image included in the modulated light 1403.

The projector 124 may be provided with a projection optical system including a Fourier transform lens, a projection lens, and the like instead of the curved face mirror 145. The projector 124 may be configured to directly project the light modulated by the modulation part 1430 of the spatial light modulator 143 without using the curved face mirror 145 or the projection optical system.

The projection control unit 147 controls the light source 141 and the spatial light modulator 143 according to the control of the controller 121. For example, the projection control unit 147 is achieved by a microcomputer or a microcontroller including a processor and a memory. The projection control unit 147 sets a phase image related to the projected image in the modulation part 1430 in accordance with the aspect ratio of tiling set in the modulation part 1430 of the spatial light modulator 143. The phase image of the projected image may be stored in advance in a storage circuit (not illustrated). The shape and the size of the image to be projected are not particularly limited.

The projection control unit 147 drives the spatial light modulator 143 in such a way that a parameter that determines a difference between a phase of the light 1401 with which the modulation part 1430 of the spatial light modulator 143 is irradiated and a phase of the modulated light 1403 reflected by the modulation part 1430 changes. For example, the parameter is a value related to optical characteristics such as a refractive index and an optical path length. For example, the projection control unit 147 adjusts the refractive index of the modulation part 1430 by changing the voltage applied to the modulation part 1430 of the spatial light modulator 143. The phase distribution of the light 1401 with which the modulation part 1430 of the phase modulation type spatial light modulator 143 is irradiated is modulated according to the optical characteristics of the modulation part 1430. The method of driving the spatial light modulator 143 by the projection control unit 147 is determined according to the modulation method of the spatial light modulator 143.

The projection control unit 147 drives the light source 141 in a state where the phase image related to the image to be displayed is set in the modulation part 1430. As a result, the modulation part 1430 of the spatial light modulator 143 is irradiated with the light 1401 emitted from the light source 141 in accordance with the timing at which the phase image is set in the modulation part 1430 of the spatial light modulator 143. The light 1401 with which the modulation part 1430 of the spatial light modulator 143 is irradiated is modulated by the modulation part 1430 of the spatial light modulator 143. The modulated light 1403 modulated by the modulation part 1430 of the spatial light modulator 143 is emitted toward the reflection surface 1450 of the curved face mirror 145.

The light receiver 125 receives the reflected light coming from the reflection device 13. The light receiver 125 changes the received reflected light into an electric signal. The light receiver 125 converts an electric signal based on the reflected light into digital data according to a modulation pattern of the reflected light. The light receiver 125 outputs the converted digital data to the controller 121.

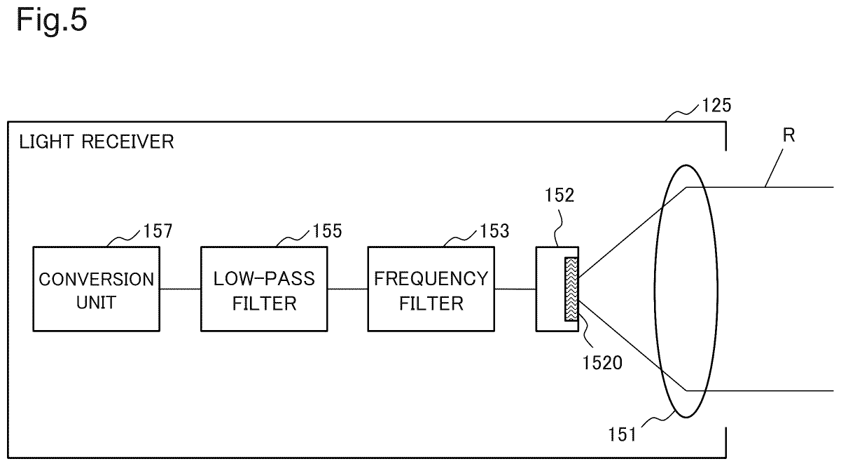

FIG. 5 is a conceptual diagram illustrating an example of a configuration of the light receiver 125. The light receiver 125 includes a condenser lens 151, a light receiving element 152, a frequency filter 153, a low-pass filter 155, and a conversion unit 157.

The condenser lens 151 is an optical element that condenses reflected light coming from the reflection device 13. The reflected light condensed by the condenser lens 151 is condensed toward a light reception unit 1520 of the light receiving element 152. The light derived from the reflected light collected by the condenser lens 151 is also referred to as an optical signal. For example, the condenser lens 151 can be made of a material such as glass or plastic. For example, the condenser lens 151 is made of a material such as quartz. When the reflected light is infrared light, a material that transmits infrared light is preferably used for the condenser lens 151. For example, in a case where the reflected light is infrared light, silicon, germanium, or a chalcogenide material is used for the condenser lens 151. The material of the condenser lens 151 is not limited as long as the condenser lens refracts and transmits the light in the wavelength region of the reflected light.

The light receiving element 152 is disposed at a subsequent stage of the condenser lens 151. The light receiving element 152 is disposed in the condensing region of the condenser lens 151. The light receiving element 152 includes the light reception unit 1520 that receives the optical signal condensed by the condenser lens 151. The light receiving element 152 is disposed in such a way that an outgoing face of the condenser lens 151 and the light reception unit 1520 face each other. In the light receiving element 152, the light reception unit 1520 receives the optical signal condensed by the condenser lens 151. The optical signal received by the light receiving element 152 has a pattern modulated by the second optical communication machine 136 of the reflection device 13. The light receiving element 152 converts the received optical signal into an electric signal. The light receiving element 152 outputs the converted electric signal to the frequency filter 153.

The light receiving element 152 receives light in a wavelength region of an optical signal that is a light receiving target. For example, the light receiving element 152 receives an optical signal in an infrared region. The light receiving element 152 receives an optical signal having a wavelength in a 0.9 μm (micrometer) band, for example. The wavelength band of the optical signal received by the light receiving element 152 is not limited to the 0.9 μm band. The wavelength band of the optical signal received by the light receiving element 152 is set in accordance with the wavelength of the projection light L projected from the projector 124. The wavelength band of the optical signal received by the light receiving element 152 may be set to, for example, a band of 0.8 μm to 1 μm, a band of 1.5 μm, a band of 1.55 μm, or a band of 2.2 μm. The light receiving element 152 may receive an optical signal in the visible region. A color filter that selectively passes the light of the wavelength band of the light receiving target may be installed in front of the light receiving element 152.

For example, the light receiving element 152 can be achieved by an element such as a photodiode or a phototransistor. For example, the light receiving element 152 is achieved by an avalanche photodiode. The light receiving element 152 achieved by the avalanche photodiode can support high speed communication. The light receiving element 152 may be achieved by an element other than a photodiode, a phototransistor, or an avalanche photodiode as long as an optical signal can be converted into an electric signal. In order to receive light coming from various directions, the light reception unit 1520 of the light receiving element is preferably as large as possible.

The frequency filter 153 acquires an electric signal related to the optical signal received by the light receiving element 152. The frequency filter 153 filters the frequency of the acquired electric signal with a carrier frequency used for communication. The electric signal filtered by the frequency filter 153 is a signal component of a carrier frequency from which unnecessary signal components have been removed. By being filtered by the frequency filter 153, a weak signal included in the electric signal can be detected. The frequency filter 153 outputs the filtered electric signal to the low-pass filter 155.

The low-pass filter 155 acquires the electric signal filtered by the frequency filter 153. The low-pass filter 155 cuts off an electric signal of a high frequency component included in the acquired electric signal, and allows an electric signal of a desired low frequency component to pass therethrough. The low-pass filter 155 passes an electric signal of a desired low frequency component based on a preset filter condition. The electric signal having passed through the low-pass filter 155 is formed into a modulation pattern of the reflected light reflected by the second optical communication machine 136. The low-pass filter 155 outputs the molded electric signal to the conversion unit 157.

The conversion unit 157 acquires an electric signal from the low-pass filter 155. The conversion unit 157 converts the acquired electric signal into digital data. The conversion unit 157 outputs the converted digital data to the controller 121. For example, the digital data output from the light receiver 125 (conversion unit 157) includes information related to the specification, the position, the orientation, and the like of the radio wave reflective plate 131 of the reflection device 13.

### Second Optical Communication Machine

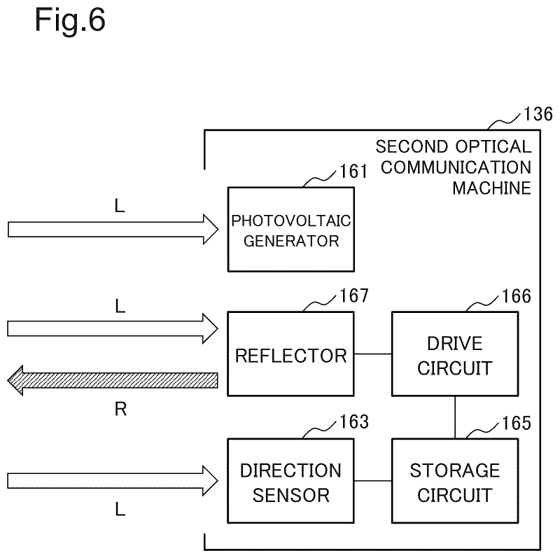

FIG. 6 is a conceptual diagram illustrating an example of a configuration of the second optical communication machine 136. FIG. 6 conceptually illustrates the projection light L projected from the first optical communication machine 112 of the communication device 11 and reflected light R of the projection light L. The second optical communication machine 136 includes a photovoltaic generator 161, a direction sensor 163, a storage circuit 165, a drive circuit 166, and a reflector 167. For example, the second optical communication machine 136 is configured to drive with power of several hundred microwatts (μW) to about 10 milliwatts (mW) generated by the photovoltaic generator 161.

The photovoltaic generator 161 receives the projection light L projected from the first optical communication machine 112 of the communication device 11. The photovoltaic generator 161 generates power by the received projection light L. The photovoltaic generator 161 supplies the generated power to the direction sensor 163, the storage circuit 165, the drive circuit 166, and the reflector 167.

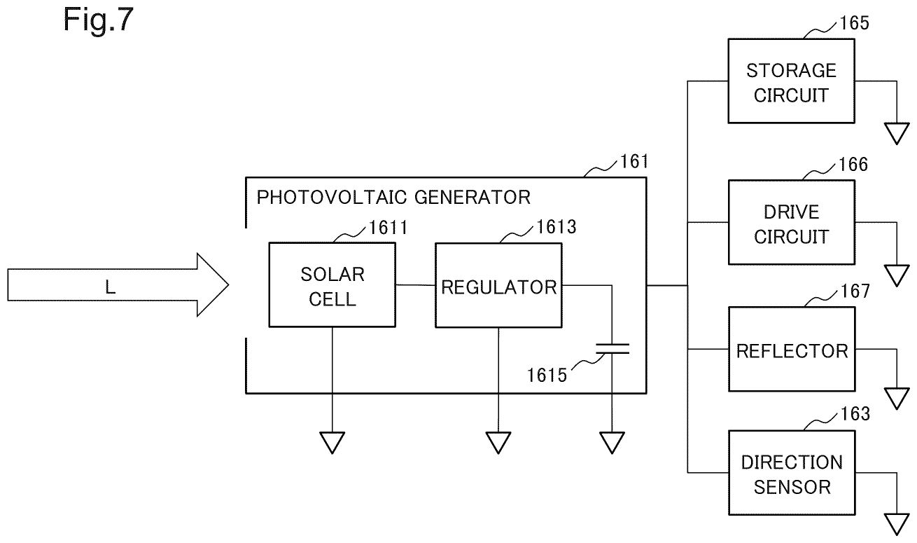

FIG. 7 is a conceptual diagram for describing an example of a configuration of the photovoltaic generator 161. The photovoltaic generator 161 includes a solar cell 1611, a regulator 1613, and a capacitor 1615.

The solar cell 1611 is a solar cell having sensitivity to the wavelength band of the projection light L. The solar cell 1611 receives the projection light L projected from the first optical communication machine 112 of the communication device 11. The solar cell 1611 generates power in response to receiving the projection light L. The electricity generated by the solar cell 1611 is supplied to the regulator 1613.

For example, the solar cell 1611 is achieved by a silicon-based, compound-based, or organic solar cell. For example, the solar cell 1611 is achieved by a single crystal silicon type solar cell or a dye-sensitized solar cell. For example, the solar cell 1611 may be achieved by a perovskite-type or quantum dot-type solar cell. For example, the solar cell 1611 generates electricity of power of several hundred μW to about 10 mW. The solar cell 1611 is not particularly limited as long as it can generate electric power operable by the components of the second optical communication machine 136.

The regulator 1613 stabilizes the voltage of the electricity generated by the solar cell 1611. For example, the regulator 1613 converts a voltage of electricity generated by the solar cell 1611 into an operating voltage of the direction sensor 163, the storage circuit 165, and the reflector 167. For example, the regulator 1613 is achieved by a three-terminal regulator.

The capacitor 1615 charges power whose voltage is stabilized by the regulator 1613. For example, the capacitor 1615 is achieved by an electric double layer capacitor. The power charged in the capacitor 1615 is supplied to the direction sensor 163, the storage circuit 165, the drive circuit 166, and the reflector 167.

The direction sensor 163 receives the projection light L projected from the first optical communication machine 112 of the communication device 11. The direction sensor 163 detects the direction from which the received projection light L arrives. The direction from which the projection light L arrives corresponds to the direction of the transmission/reception face 1110 of the phased array antenna 111 included in the communication device 11 with respect to the reflection surface 1310 of the reflection device 13. The direction sensor 163 stores data related to the detected direction (also referred to as direction data) in the storage circuit 165.

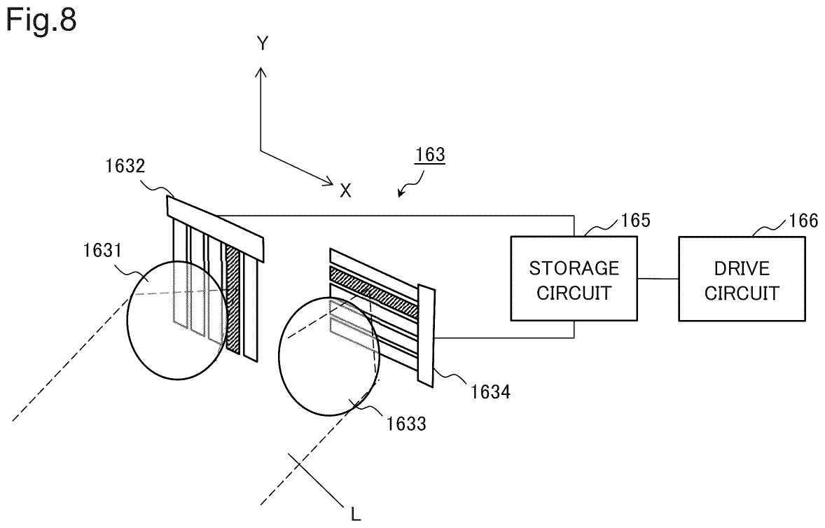

FIG. 8 is a conceptual diagram illustrating an example of a configuration of the direction sensor 163. The direction sensor 163 includes a first condenser lens 1631, a first direction sensor 1632, a second condenser lens 1633, and a second direction sensor 1634.

The first condenser lens 1631 condenses light toward the first direction sensor 1632. The light receiving face of the first condenser lens 1631 is directed in the direction same as that of the reflection surface 1310 of the reflection device 13. The first condenser lens 1631 has a configuration similar to that of the condenser lens 151 of the light receiver 125. The light condensed by the first condenser lens 1631 is received by the first direction sensor 1632.

The first direction sensor 1632 is disposed at the condensing position of the first condenser lens 1631. The first direction sensor 1632 includes a plurality of strip-shaped light detection units (also referred to as first optical sensors). The plurality of light detection units is aligned in the major axis direction and disposed in the minor axis direction. The major axis of the light detection unit is disposed along a direction (Y direction) perpendicular to the horizontal plane. A direction (Y direction) perpendicular to the horizontal plane is also referred to as a first direction. The minor axis of the light detection unit is disposed along a direction (X direction) horizontal to the horizontal plane. The light receiving faces of the plurality of detection units included in the first direction sensor 1632 are directed in the direction same as that of the reflection surface 1310 of the reflection device 13.

The first direction sensor 1632 detects a direction from which light in a plane (XY plane) perpendicular to a horizontal plane arrives according to the light detection unit irradiated with the light. In FIG. 8, a state in which light is condensed on the second light detection unit from the right is indicated by hatching. The first direction sensor 1632 writes data (also referred to as first direction data) related to an address (X coordinate) of the light detection unit that has detected light to the storage circuit 165. When light is detected by the plurality of light detection units, the first direction sensor 1632 writes first direction data related to the first address (X coordinate) of the light detection unit having the maximum intensity or energy of the received light to the storage circuit 165. The first direction sensor 1632 may be configured to set the first direction data in a transmission data register (not illustrated) in which transmission data is stored.

The second condenser lens 1633 condenses light toward the second direction sensor 1634. The light receiving face of the second condenser lens 1633 is directed in the direction same as that of the reflection surface 1310 of the reflection device 13. The second condenser lens 1633 has a configuration similar to that of the condenser lens 151 of the light receiver 125 and the first condenser lens 1631. The light condensed by the second condenser lens 1633 is received by the second direction sensor 1634.

The second direction sensor 1634 is disposed at the condensing position of the second condenser lens 1633. The second direction sensor 1634 includes a plurality of strip-shaped light detection units (also referred to as second optical sensors). The plurality of light detection units is aligned in the major axis direction and disposed in the minor axis direction. The major axis of the light detection unit is disposed along a direction (X direction) horizontal to the horizontal plane. A direction (X direction) horizontal to the horizontal plane is also referred to as a second direction. The first direction and the second direction are orthogonal to each other. The minor axis of the light detection unit is disposed along a direction (Y direction) perpendicular to the horizontal plane. The light receiving faces of the plurality of detection units included in the second direction sensor 1634 are directed in the direction same as that of the reflection surface 1310 of the reflection device 13.

The second direction sensor 1634 detects a direction from which light in a plane (XY plane) perpendicular to the horizontal plane arrives according to the light detection unit irradiated with the light. In FIG. 8, a state in which light is condensed on the second light detection unit from the top is indicated by hatching. The second direction sensor 1634 writes data (also referred to as second direction data) related to an address (Y coordinate) of the light detection unit that has detected light to the storage circuit 165. When the light is detected by the plurality of light detection units, the second direction sensor 1634 writes the second direction data related to the address (Y coordinate) of the light detection unit having the maximum intensity or energy of the received light to the storage circuit 165. The second direction sensor 1634 may be configured to set the second direction data in a transmission data register (not illustrated) in which transmission data is stored.

The storage circuit 165 is a storage device that stores data. For example, the storage circuit 165 is achieved by a storage device such as a memory or a register. The storage circuit 165 stores data (also referred to as device data) related to the reflection device 13. The device data related to the reflection device 13 includes an identifier (ID) of the reflection device 13, position information related to a position where the reflection device 13 is disposed, performance of the radio wave reflective plate 131 (RIS reflective plate) of the reflection device 13, and the like. The device data is stored in advance in the storage circuit 165. For example, the device data related to the reflection device 13 is set in a transmission data register (not illustrated) in response to activation of the second optical communication machine 136 by reception of the projection light L. The transmission data register temporarily stores data (also referred to as transmission data) to be transmitted toward the communication device 11.

The direction data of the communication device 11 is written in the storage circuit 165. The direction data of the communication device 11 corresponds to the direction of the reflection surface 1310 of the reflection device 13 with respect to the transmission/reception face 1110 of the phased array antenna 111 included in the communication device 11. The direction data includes the first direction data output from the first direction sensor 1632 and the second direction data output from the second direction sensor 1634. For example, the direction data indicating the direction (position) of the reflection device 13 is added to the device data related to the reflection device 13. For example, the direction data is added to the device data set in the transmission data register. Data including the device data and the direction data is transmission data. The transmission data is generated in association with the communication device 11 that is the projection source of the projection light L. The transmission data is referred to by the drive circuit 166.

The drive circuit 166 (also referred to as a driver) acquires transmission data stored in the storage circuit 165. When the transmission data is set in the transmission data register, the drive circuit 166 acquires the transmission data set in the transmission data register. The drive circuit 166 controls the reflector 167 according to the acquired pattern of the transmission data. For example, in a case where the transmission data is binarized into logical values of “0” and “1”, the drive circuit 166 controls the reflector 167 in such a way that reflection by the reflector 167 is turned off at timing when the transmission data is “0”. On the other hand, the drive circuit 166 controls the reflector 167 in such a way that the reflection by the reflector 167 is turned on at the timing when the transmission data is “1”. At the timing when the transmission data is “0”, the reflected light R is not emitted from the reflector 167. On the other hand, at the timing when the transmission data is “1”, the reflected light R is emitted from the reflector 167. That is, the pattern of the logical value of the transmission data is converted into the blinking pattern of the reflected light R. In other words, the blinking pattern of the reflected light R is modulated in association with the pattern of the logical value of the transmission data. The communication device 11 (first optical communication machine 112) can decode an array of logical values of transmission data as information included in the transmission data according to the blinking pattern of the reflected light R.

The reflector 167 includes a retroreflective plate that retroreflects light. A shutter that can be electrically opened and closed is disposed on the incident face side of the retroreflective plate. The shutter is opened and closed in accordance with driving of the drive circuit 166.

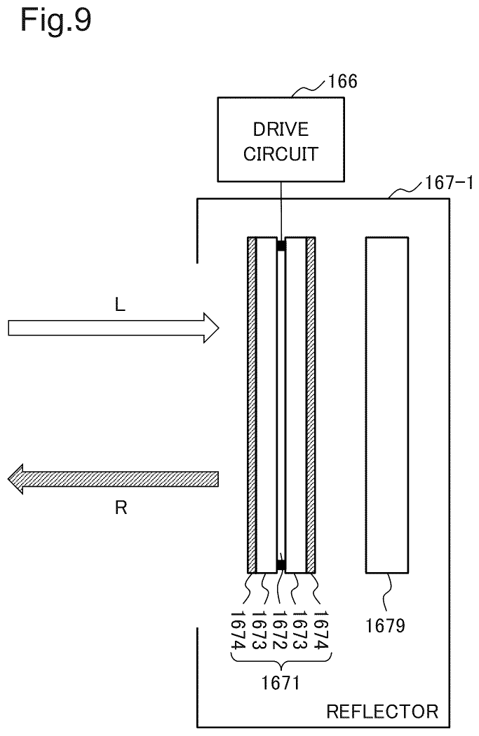

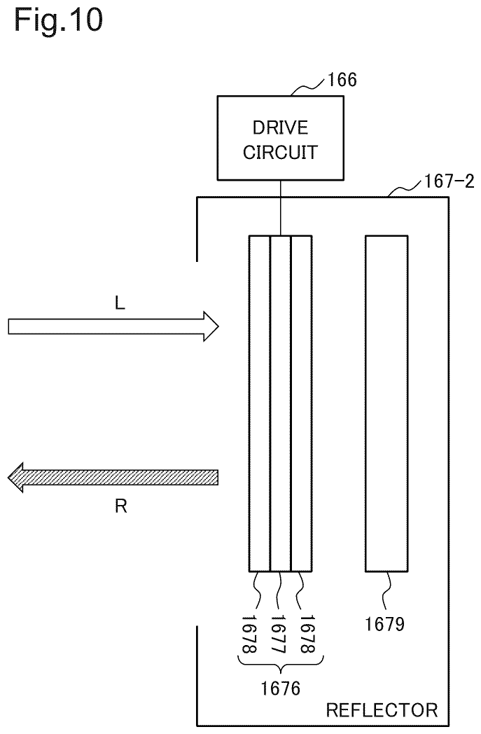

FIG. 9 is a conceptual diagram for describing an example of the reflector 167 (reflector 167-1). The reflector 167-1 includes a shutter 1671 and a retroreflective plate 1679. The shutter 1671 is disposed close to the incident face of the retroreflective plate 1679.

The shutter 1671 includes a liquid crystal layer 1672, a transparent substrate 1673, and a polarizing plate 1674. Liquid crystal molecules are dispersed in the liquid crystal layer 1672. The liquid crystal layer 1672 is held between the two transparent substrates 1673. A configuration in which the liquid crystal layer 1672 is held by the two transparent substrates 1673 is a liquid crystal panel. For example, a twisted nematic (TN) panel having a high reaction speed is used as the liquid crystal panel. The polarizing plates 1674 are disposed on both faces of the liquid crystal panel. Polarization directions of two polarizing plates 1674 disposed on both faces of the liquid crystal panel are orthogonal to each other. The transparent substrate 1673 is a transparent polymer or glass. A transparent electrode is formed on the transparent substrate 1673. In a state where no voltage is applied between the two transparent substrates 1673, light passes through the shutter 1671. When a voltage is applied between the two transparent substrates 1673, the shutter 1671 blocks light. The shutter 1671 is opened in a state where no voltage is applied, and is closed in a state where a voltage is applied. For example, a vertical alignment (VA) panel or an in-plane switching (IPS) panel may be used as the liquid crystal panel.

The retroreflective plate 1679 has a reflection surface that retroreflects incident light. That is, the retroreflective plate 1679 retroreflects the projection light L incident on the reflection surface in the incidence direction of the projection light L. In a state where the shutter 1671 is open, the retroreflective plate 1679 retroreflects the incident projection light L. In a state where the shutter 1671 is closed, the projection light L is not incident on the retroreflective plate 1679. Therefore, when shutter 1671 is closed, the reflected light R is not emitted.

For example, the retroreflective plate 1679 has a reflection surface including a glass bead-type retroreflective structure. The glass bead-type retroreflective structure is a structure in which a plurality of minute transparent spheres is disposed on one face of a sheet. The light incident on the transparent sphere is refracted at the incident position of the transparent sphere, and travels inside the transparent sphere. The light reaching the sheet side is reflected. The light reflected on the sheet side travels inside the transparent sphere, is refracted at an emission position of the transparent sphere, and is emitted. As a result, the reflected light R reflected by the retroreflective plate 1679 travels toward the communication device 11 (first optical communication machine 112) that is the projection source of the projection light L along the incidence direction of the projection light L.

For example, the retroreflective plate 1679 has a reflection surface including a microprism-type retroreflective structure. The microprism-type retroreflective structure is a structure in which a plurality of minute transparent triangular pyramids (microprisms) is disposed in a sheet shape sharing a bottom face. The plurality of microprisms is arrayed with the apex facing opposite to the light incident face. The bottom face of the plurality of micro-prisms forms an incident face/outgoing face. The light incident on the bottom face of the microprism travels inside the microprism and is reflected by a plurality of side faces of the microprism. The light reflected by the plurality of side faces of the microprism is emitted from the bottom face of the microprism. As a result, the reflected light R reflected by the retroreflective plate 1679 returns toward the communication device 11 (first optical communication machine 112) that is the projection source of the projection light L along the incidence direction of the projection light L.

FIG. 10 is a conceptual diagram for describing another example (reflector 167-2) of the reflector 167. The reflector 167-2 includes a shutter 1676 and the retroreflective plate 1679. The shutter 1676 is disposed close to the incident face of the retroreflective plate 1679. The retroreflective plate 1679 has a configuration similar to that included in the reflector 167-1 in FIG. 9.

The shutter 1676 includes a liquid crystal film 1677 and a transparent substrate 1678. The liquid crystal film 1677 is held between the two transparent substrates 1678. A configuration in which the liquid crystal film 1677 is held by the two transparent substrates 1678 is a liquid crystal panel. For example, liquid crystal film 1677 is a film in which liquid crystal droplets are dispersed in a transparent polymer matrix. The transparent substrate 1678 is transparent glass or polymer. A transparent electrode is formed on the transparent substrate 1678. In a state where no voltage is applied between the two transparent substrates 1678, the shutter 1676 blocks light. When a voltage is applied between the two transparent substrates 1678, light passes through the shutter 1676. Unlike the shutter 1671, the shutter 1676 closes when no voltage is applied and opens when a voltage is applied. For example, a polymer dispersed liquid crystal (PDLC) film is used for the liquid crystal panel. A polymer network liquid crystal (PNLC) film may be used for the liquid crystal panel. In the configuration of shutter 1676, no polarizing plates are disposed on both faces of the liquid crystal panel. Therefore, the shutter 1676 has higher reflection luminance than shutter 1671 (FIG. 9).

The shutter 1676 is opened and closed under the control of the drive circuit 166. An opening/closing pattern related to the pattern of the transmission data is set in the shutter 1676. The reflected light R is modulated by opening and closing the shutter 1676 in an opening/closing pattern according to the pattern of the transmission data. The modulated reflected light R travels toward the communication device 11 (the first optical communication machine 112) that is the projection source of the projection light L.

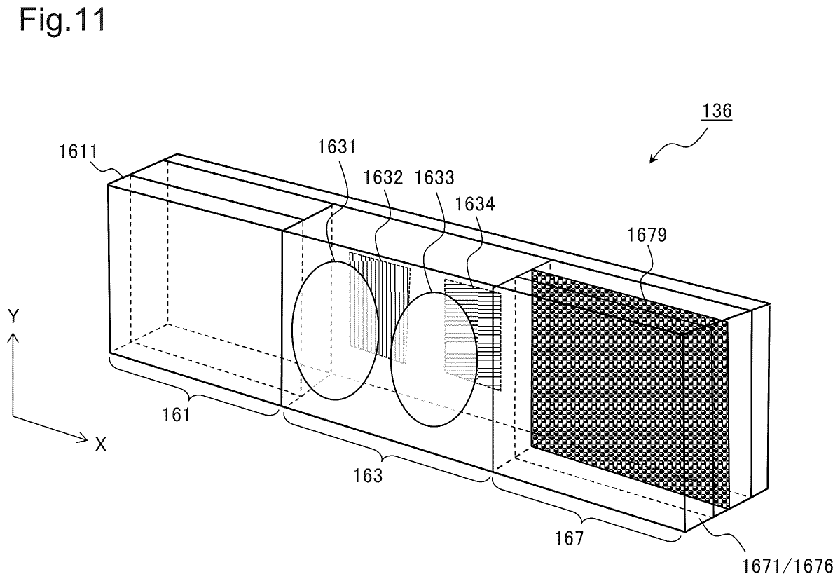

FIG. 11 is a conceptual diagram illustrating a configuration example of the second optical communication machine 136. FIG. 11 is a perspective view of the second optical communication machine 136 when viewed from a viewing from the light transmitting/receiving face 1360. FIG. 11 includes a transmission diagram of part of the components disposed inside the second optical communication machine 136. The second optical communication machine 136 in FIG. 11 has a configuration in which the photovoltaic generator 161, the direction sensor 163, and the reflector 167 are arranged in the X direction. In FIG. 11, the storage circuit 165 and the drive circuit 166 are omitted. The storage circuit 165 and the drive circuit 166 may be disposed in a gap on the back side or the like of the photovoltaic generator 161, the direction sensor 163 and the reflector 167. The configuration of FIG. 11 is an example of the second optical communication machine 136 according to the present example embodiment. The configuration of the second optical communication machine 136 according to the present example embodiment is not limited to the configuration of FIG. 11.

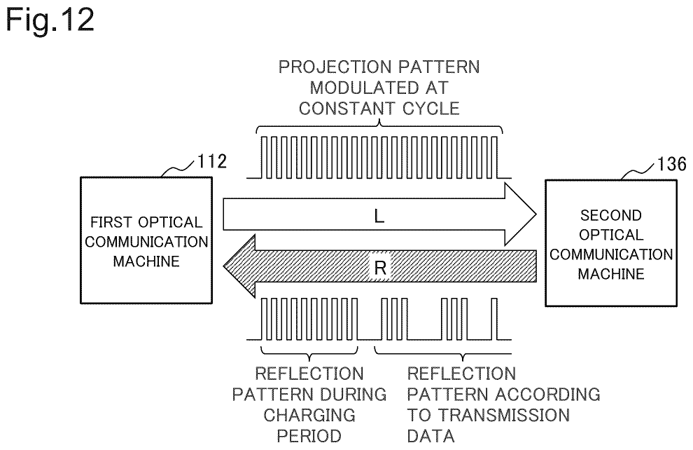

FIG. 12 is a conceptual diagram for describing exchange of light (also referred to as communication light) between the first optical communication machine 112 and the second optical communication machine 136. FIG. 12 illustrates pulse patterns related to blinking patterns of the projection light L and the reflected light R. The communication light is a generic term for the projection light L and the reflected light R. The projection light L includes a projection pattern modulated at a constant cycle. The reflected light R includes a reflection pattern during the charging period and a reflection pattern related to the transmission data.

The projection light L projected from the first optical communication machine 112 is modulated at a constant cycle. The pulse width of the projection light L is constant. The projection light L projected from the first optical communication machine 112 is reflected by the second optical communication machine 136. The reflected light R reflected by the second optical communication machine 136 is retroreflected toward the first optical communication machine 112. FIG. 12 illustrates an example in which the second optical communication machine 136 includes the shutter 1671 (FIG. 9). The shutter 1671 is open when not energized. Therefore, during the charging period in which power is not supplied from the photovoltaic generator 161, the reflected light R having the same pulse pattern as the projection light L is emitted from the second optical communication machine 136. The charging period of FIG. 12 includes, in addition to the actual charging period of the photovoltaic generator 161, the detection period during which the direction from which the projection light L arrives is detected by the direction sensor 163, and another period. When the second optical communication machine 136 includes the shutter 1676 (FIG. 10), the reflected light R is not emitted during the charging period.

The direction sensor 163 is activated when power is supplied from the photovoltaic generator 161. The activated direction sensor 163 detects a direction from which the projection light L arrives. When the direction from which the projection light L arrives is identified, the second optical communication machine 136 opens and closes the shutter 1671 in an opening/closing pattern related to the transmission data. As a result, the reflected light R having the blinking pattern related to the transmission data is emitted.

When receiving the reflected light R, the first optical communication machine 112 converts the reflected light R into digital data. The first optical communication machine 112 acquires device data related to the reflection device 13 in which the second optical communication machine 136 is installed according to the pattern of the converted digital data. For example, the first optical communication machine 112 acquires an identifier (ID) of the reflection device 13, position information about a position where the reflection device 13 is disposed, and device data regarding performance of the radio wave reflective plate 131 (RIS reflective plate) of the reflection device 13 and the like. The first optical communication machine 112 acquires direction data regarding the direction of the reflection surface 1310 of the radio wave reflective plate 131 of the reflection device 13. The communication device 11 searches for a communication target using the reflection device 13 according to the acquired device data and direction data.

When communication with a communication target is established, the communication device 11 starts wireless communication using the reflection device 13 with the communication target. Communication with the communication target may be interrupted according to a change in a positional relationship between the communication device 11 and the communication target. In such a case, the communication device 11 searches for the reflection device 13 capable of communicating with the communication target at the timing when the communication is interrupted or at the timing when the communication is predicted to be interrupted. When the reflection device 13 capable of communicating with the communication target is searched for, the communication device 11 switches to communication using the reflection device 13. By repeating these processes, the communication device 11 can continue communication with the communication target.

### Operation

Next, an operation of the communication system 1 will be described with reference to the drawings. Hereinafter, a cooperative operation between the communication device 11 and the reflection device 13 constituting the communication system 1 and individual operations of the communication device 11 and the reflection device 13 will be described.

### Cooperative Operation

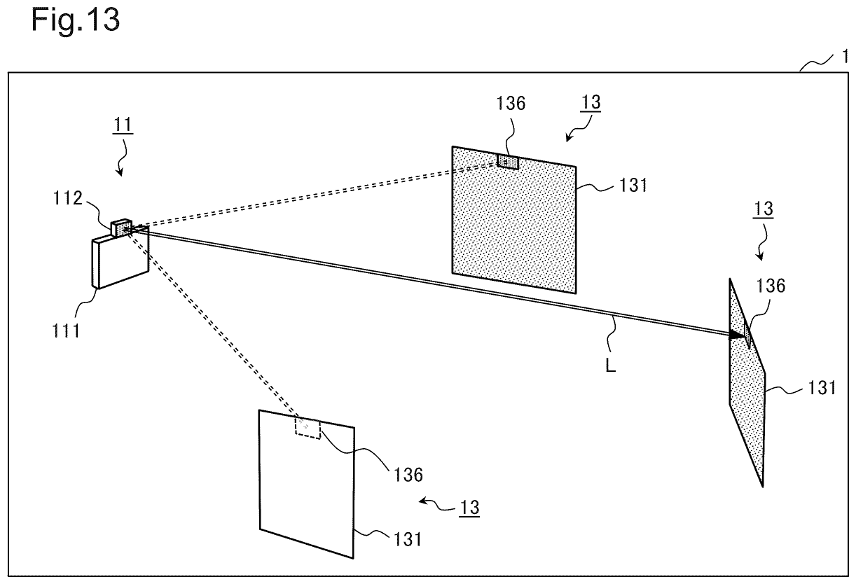

FIGS. 13 to 15 are conceptual diagrams for describing a cooperative operation between the communication device 11 and the reflection device 13 in the communication system 1. FIGS. 13 to 15 illustrate examples in which communication is established collectively between the communication device 11 and the plurality of reflection devices 13. In practice, communication between the communication device 11 and the plurality of reflection devices 13 is individually established for each reflection device 13 by scanning with the projection light L.

FIG. 13 illustrates a state in which the projection light L is projected from the first optical communication machine 112 of the communication device 11. The projection light L is received by the second optical communication machine 136 of any of the reflection devices 13. The solar cell 1611 included in the second optical communication machine 136 of the reflection device 13 that has received the projection light L generates power in response to receiving the projection light L from the first optical communication machine 112. FIG. 13 illustrates an example in which the second optical communication machine 136 of the reflection device 13 at the right end is simultaneously irradiated with the projection light L.

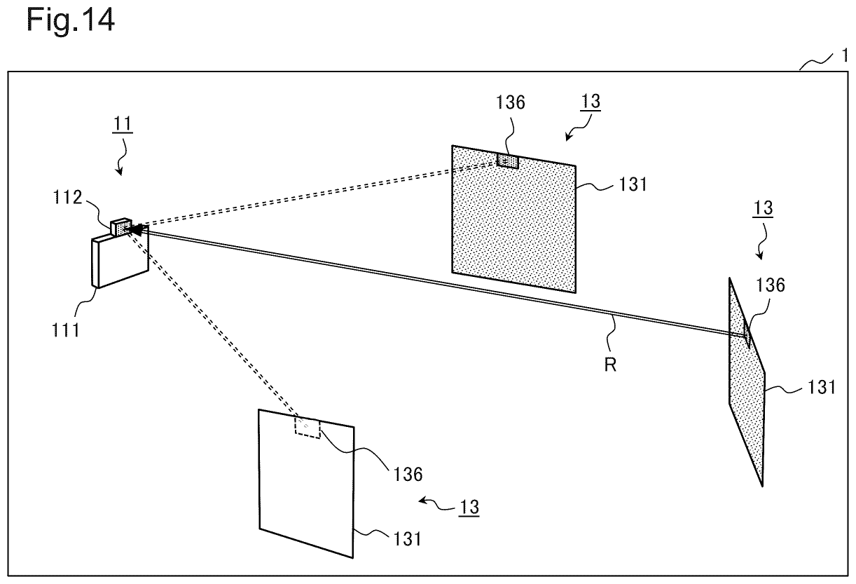

FIG. 14 illustrates a state in which the reflected light R is emitted from the second optical communication machine 136 activated in response to the power generation by the solar cell 1611 toward the first optical communication machine 112 that is the projection source of the projection light L. The first optical communication machine 112 acquires transmission data of the reflection device 13 in which the second optical communication machine 136 is installed according to the modulation pattern of the reflected light R received from the second optical communication machine 136. The first optical communication machine 112 selects the reflection device 13 to be used for communication with the communication target according to the device data and the direction data included in the acquired transmission data of the reflection device 13. The communication device 11 may include a plurality of light receivers 125 in such a way that the reflected light R from the plurality of reflection devices 13 can be simultaneously received and processed. In a case where the reflected light R simultaneously arrives from the second optical communication machine 136 of the plurality of reflection devices 13, the communication device 11 may execute the light reception processing in time series for each reflection device 13.

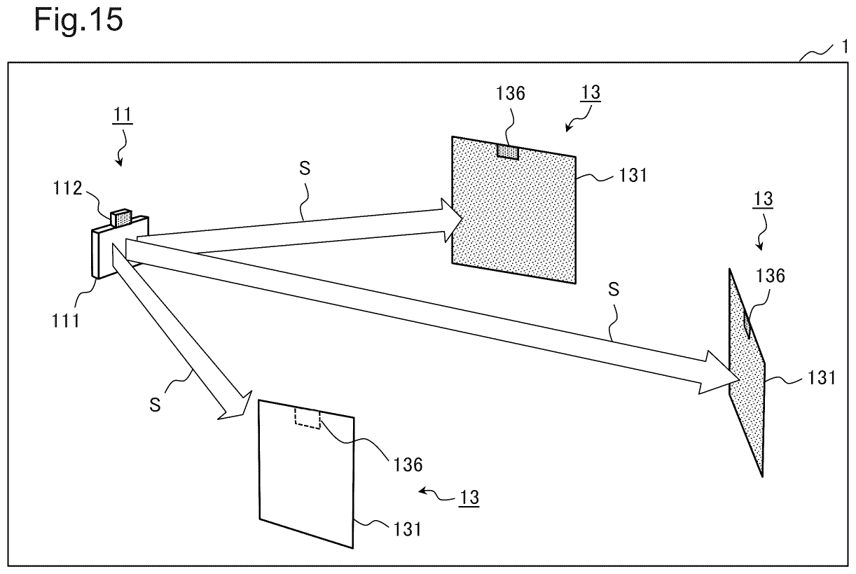

FIG. 15 illustrates a state in which a radio signal S is transmitted from phased array antenna 111 of communication device 11 toward the reflection device 13 in response to receiving the reflected light R from the reflection device 13. The communication device 11 allocates an antenna unit to the phased array antenna 111 with respect to the reflection device 13 that is the reflection source of the reflected light R. The communication device 11 transmits the radio signal S from the antenna unit allocated to the reflection device 13 to the reflection device 13. The communication device 11 searches for a communication target and communicates with the searched communication device using the reflection device 13. For example, the communication device 11 searches for the reflection device 13 at a predetermined timing. For example, the communication device 11 searches for the reflection device 13 at the timing of initial setting of the communication system 1. For example, the communication device 11 searches for the reflection device 13 in accordance with the timing of the search for the communication target by the communication device 11.

### Communication Device

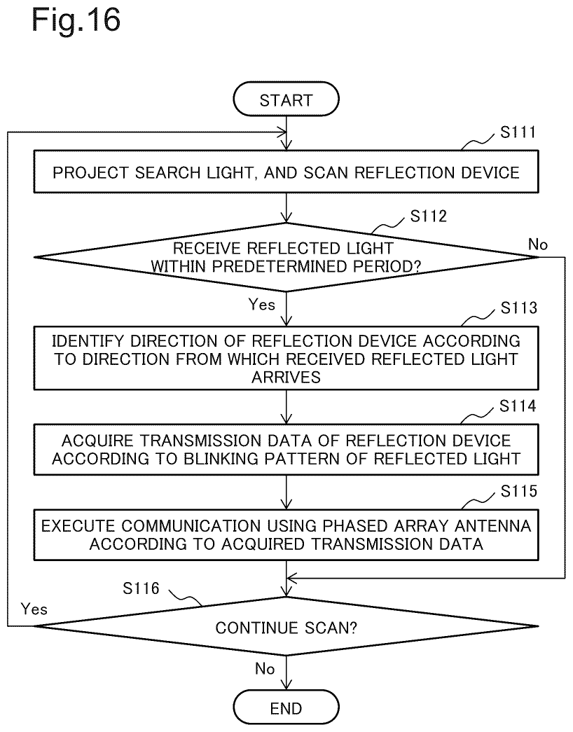

FIG. 16 is a flowchart for describing the operation of the communication device 11. In the description of the process along the flowchart of FIG. 16, the communication device 11 will be described as an operation subject. For example, the process along the flowchart of FIG. 16 is executed in a case where the communication device 11 or the reflection device 13 is newly installed. The process along the flowchart of FIG. 16 may be executed for each search for a communication target by the communication device 11.

In FIG. 16, first, the communication device 11 projects search light and scans the reflection device 13 (step S111). The communication device 11 projects the search light from the projector 124 of the first optical communication machine 112. The communication device 11 scans the reflection device 13 located inside the coverage of the radio wave radiated from the phased array antenna 111.

When the reflected light is received within the predetermined period (Yes in step S112), the communication device 11 identifies the direction of the reflection device 13 according to the direction from which the received reflected light arrives (step S113). The predetermined period is a period set in a single projection direction or a single projection range. The predetermined period is a preset period. When the reflected light is not received within the predetermined period (No in step S112), the process proceeds to step S116.

After step S113, the communication device 11 acquires the transmission data of the reflection device 13 according to the blinking pattern of the reflected light (step S114). The communication device 11 acquires the transmission data of the reflection device 13 based on the pattern of the digital data according to the blinking pattern of the reflected light.

Next, the communication device 11 executes communication using the phased array antenna 111 according to the acquired transmission data (step S115). The communication device 11 identifies the state of the reflection surface 1310 of the reflection device 13 based on the device data included in the transmission data. The communication device 11 identifies the direction of the reflection surface 1310 of the reflection device 13 based on the direction data included in the transmission data. As the communication using the phased array antenna 111, the communication device 11 executes allocation of an antenna unit to the reflection device 13, search for a communication target, establishment of communication with the searched communication target, and communication with the established communication target.

After step S116 or when No in step S112, the communication device 11 determines whether to continue scanning the reflection device 13 (step S116). When scanning is continued (Yes in step S116), the process returns to step S111. When the scanning is ended (No in step S116), the process along the flowchart of FIG. 16 is ended. Conditions for continuation/termination of scanning may be set in advance.

### Reflection Device

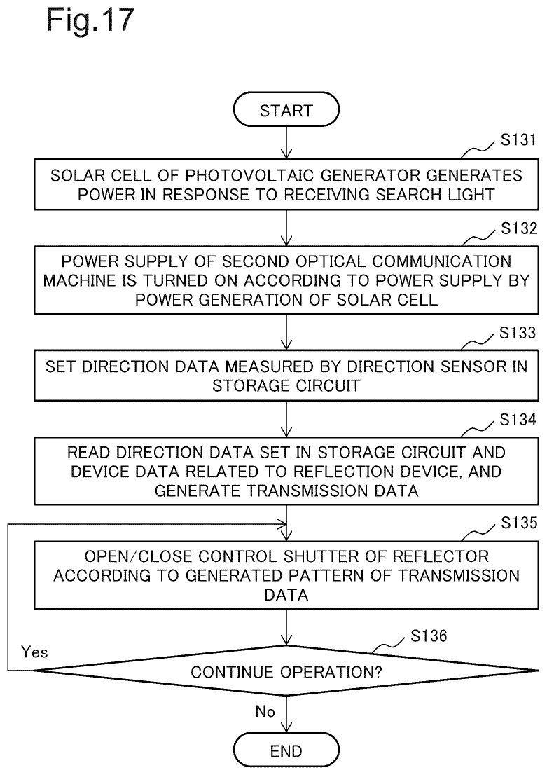

Next, the operation of the reflection device 13 will be described with reference to the drawings. FIG. 17 is a flowchart for describing the operation of the reflection device 13. In the description of the process along the flowchart of FIG. 17, the second optical communication machine 136 included in the reflection device 13 will be described as the operation subject. The processing of the flowchart of FIG. 17 also includes power generation of the solar cell 1611 of the photovoltaic generator 161 included in the second optical communication machine 136 of the reflection device 13, activation of the second optical communication machine 136 according to power supply by the solar cell 1611, and the like.

In FIG. 17, first, in response to receiving the projection light from the first optical communication machine 112 of the communication device 11, the solar cell 1611 of the photovoltaic generator 161 included in the second optical communication machine 136 of the reflection device 13 starts power generation (step S131).

Next, the power of the second optical communication machine 136 is turned on according to the power supply by the power generation of the solar cell 1611 (step S132). Before the projection light is received, the first optical communication machine 112 may be activated according to the power generation of the solar cell 1611 by the ambient light. Since the ambient light is not constant in the arrival direction and is not patterned at a constant cycle, the ambient light can be distinguished from the projection light.

Next, the second optical communication machine 136 sets direction data measured by the direction sensor 163 in the storage circuit 165 (step S133). The second optical communication machine 136 may set direction data in a transmission data register (not illustrated).

Next, the second optical communication machine 136 reads the direction data set in the storage circuit 165 and the device data related to the reflection device 13 from the storage circuit 165, and generates transmission data (step S134). The transmission data includes the direction data and the device data.

Next, the second optical communication machine 136 performs opening/closing control of the shutter of the reflector 167 according to the generated pattern of the transmission data (step S135). Reflected light modulated according to transmission data is emitted toward the first optical communication machine 112 of the communication device 11 according to opening/closing control of the shutter of the reflector 167.

When the operation is continued (Yes in step S136), the process returns to step S135. When the operation is ended (No in step S136), the process along the flowchart of FIG. 17 is ended. The determination criterion for continuation of the operation may be set in advance. For example, the second optical communication machine 136 terminates the operation in response to receiving the radio wave from the communication device 11. For example, the operation of the second optical communication machine 136 ends at the timing when the projection of the projection light by the communication device 11 ends and the power generation by the solar cell 1611 ends.

As described above, the communication system of the present example embodiment includes the communication device and the plurality of reflection devices. The communication device includes the phased array antenna and the first optical communication machine. The reflection device includes radio wave reflection and a second optical communication machine.

The phased array antennas transmit beamformed radio waves. The first optical communication machine is associated with the phased array antenna. The first optical communication machine projects projection light toward the second optical communication machine associated with the radio wave reflective plate. The first optical communication machine acquires transmission data related to the radio wave reflective plate according to the pattern of the reflected light from the second optical communication machine. The first optical communication machine controls the phased array antenna according to the acquired transmission data.

The radio wave reflective plate has a reflection surface having a meta-surface structure. The second optical communication machine is associated with the radio wave reflective plate. The second optical communication machine is activated in response to receiving projection light projected from the first optical communication machine. The second optical communication machine generates direction data related to a direction from which the projection light arrives. The second optical communication machine retroreflects, toward the first optical communication machine, the reflected light of the projection light modulated in a pattern according to transmission data including the device data and the direction data related to the radio wave reflective plate.

The communication system according to the present example embodiment includes a radio wave reflective plate controlled by a second optical communication machine that is activated in response to receiving projection light projected from the first optical communication machine. Therefore, the communication system of the present example embodiment can continuously communicate with a desired communication target even in an environment where power supply is difficult.

In an aspect of the present example embodiment, the first optical communication machine includes a projector, a light receiver, and a controller. The projector projects projection light. The light receiver receives reflected light from the second optical communication machine. The light receiver generates digital data related to the pattern of the received reflected light. The controller causes the projector to project projection light. The controller acquires transmission data related to the radio wave reflective plate from the digital data generated by the light receiver. The controller causes the phased array antenna to transmit a radio wave toward the radio wave reflective plate according to the acquired transmission data. According to the present aspect, the radio wave directed to the radio wave reflective plate can be transmitted from the phased array antenna according to the transmission data related to the radio wave reflective plate acquired based on the digital data according to the pattern of the reflected light.

In an aspect of the present example embodiment, the second optical communication machine includes a storage circuit, a photovoltaic generator, a direction sensor, a reflector, and a drive circuit. The storage circuit stores device data related to the associated radio wave reflective plate. The photovoltaic generator generates power in response to receiving projection light. The direction sensor detects a direction from which the projection light arrives. The direction sensor stores direction data related to the detected direction in the storage circuit. The reflector includes a retroreflective plate including a reflection surface that retroreflects projection light, and a shutter that is opened and closed by electrical control. The drive circuit generates transmission data including the device data and the direction data that are stored in the storage circuit. The drive circuit opens and closes the shutter in a pattern according to the generated transmission data. According to the present aspect, by supplying power to the second optical communication machine associated with the radio wave reflective plate according to the projection light projected from the first optical communication machine, the radio wave reflective plate can be disposed even in an environment where power supply is difficult. According to the present aspect, by opening and closing the shutter in a pattern according to the transmission data, the reflected light modulated in the pattern according to the transmission data can be reflected from the second optical communication machine toward the first optical communication machine.

In an aspect of the present example embodiment, the first optical communication machine projects projection light modulated in a pattern of a constant cycle. The second optical communication machine opens and closes the shutter in a pattern according to the transmission data, and reflects the reflected light modulated in the pattern according to the transmission data. According to the present aspect, the communication device including the first optical communication machine can acquire the information about the radio wave reflective plate associated with the second optical communication machine according to the blinking pattern of the reflected light.

In an aspect of the present example embodiment, the direction sensor includes a first direction sensor, a first condenser lens, a second direction sensor, and a second condenser lens. The first direction sensor includes a plurality of strip-shaped first optical sensors each having a major axis along the first direction. The first direction sensor has a structure in which a plurality of first optical sensors is disposed along a second direction orthogonal to the first direction. The first condenser lens condenses the projection light to at least any one of the plurality of first optical sensors included in the first direction sensor according to the direction from which the projection light arrives. The second direction sensor includes a plurality of strip-shaped second optical sensors each having a major axis along the second direction. The second direction sensor has a structure in which a plurality of second optical sensors is disposed along the first direction. The second condenser lens condenses the projection light to at least any one of the plurality of second optical sensors included in the second direction sensor according to the direction from which the projection light arrives. According to the present aspect, the direction from which the projection light arrives can be accurately detected by the direction sensor.

### Second Example Embodiment

Next, a communication system according to a second example embodiment will be described with reference to the drawings. A communication system of the present example embodiment is different from that of the first example embodiment in that a reflection state of a radio wave reflective plate (RIS) is actively controlled in response to a request from a communication device.

### Configuration

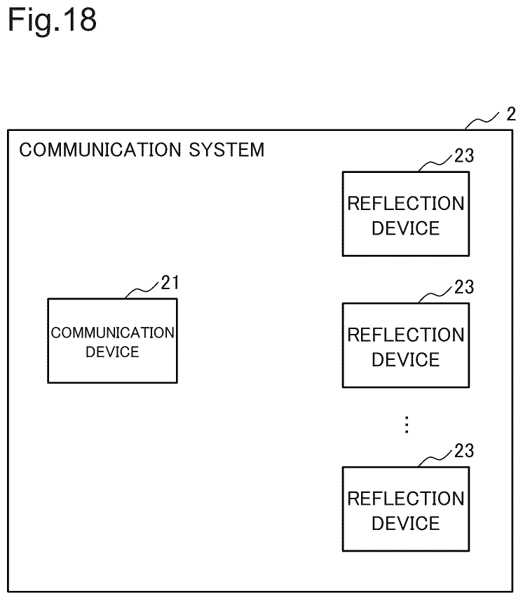

FIG. 18 is a block diagram illustrating an example of a configuration of a communication system 2 according to the present example embodiment. The communication system 2 includes a communication device 21 and a reflection device 23. In the present example embodiment, an example in which the communication system 2 is configured by the single communication device 21 and a plurality of reflection devices 23 will be described. The communication system 2 may include a plurality of communication devices 21. The communication system 2 may include at least one reflection device 23. The communication system 2 may be configured by the single reflection device 23.

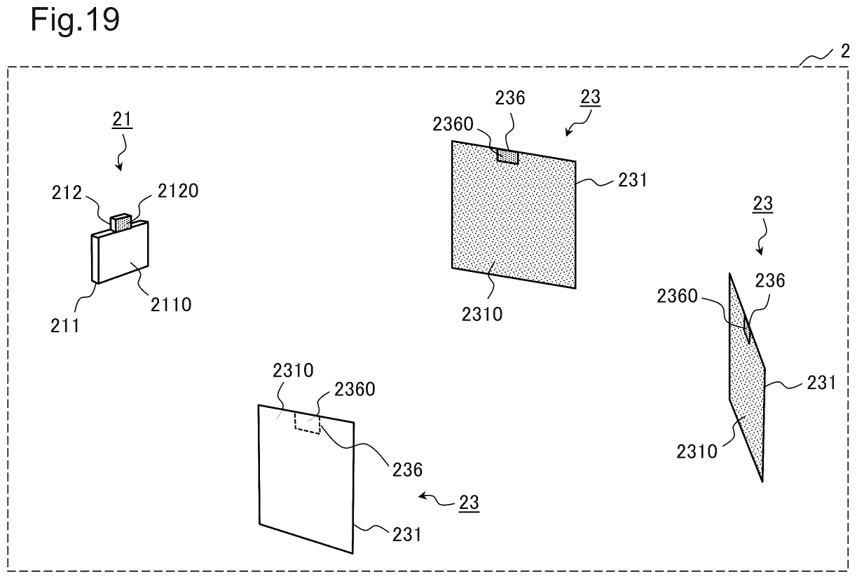

FIG. 19 is a conceptual diagram illustrating an example of a positional relationship between the communication device 21 and the reflection device 23. The communication device 21 includes a phased array antenna 211 and a first optical communication machine 212. The reflection device 23 includes a radio wave reflective plate 231 and a second optical communication machine 236. In the following description, points different from the first example embodiment will be focused.

The phased array antenna 211 has a configuration similar to that of the phased array antenna 111 of the first example embodiment. The phased array antenna 211 includes a transmission/reception face 2110 used for transmission and reception of radio waves. A plurality of antenna elements is disposed on the transmission/reception face 2110 of the phased array antenna 211. The plurality of antenna elements is regularly disposed in such a way that transmitted radio waves are beamformed.

The first optical communication machine 212 has a configuration similar to that of the first optical communication machine 112 of the first example embodiment. The first optical communication machine 212 is different from the first optical communication machine 112 of the first example embodiment in that projection light (also referred to as request light) including a request of the reflection device 23 and projection light (also referred to as information light) including information about the detected communication target are projected. The first optical communication machine 212 includes a light transmitting/receiving face 2120 for transmitting and receiving optical signals. The transmission/reception face 2110 of the phased array antenna 211 and the light transmitting/receiving face 2120 of the first optical communication machine 212 are directed in the same direction. The first optical communication machine 212 projects projection light from the light transmitting/receiving face 2120 to the second optical communication machine 236 of the reflection device 23. For example, the first optical communication machine 212 projects laser light modulated at a constant cycle. The projection light projected from the first optical communication machine 212 serves as a power supply source to the solar cell that operates the second optical communication machine 236 of the reflection device 23.

The first optical communication machine 212 emits projection light (also referred to as request light) including a request of the reflection device 23. Furthermore, the first optical communication machine 212 projects projection light (also referred to as information light) including information about the detected communication target. The request light and the information light are modulated in a pattern related to information to be transmitted.

The first optical communication machine 212 receives the reflected light reflected by the second optical communication machine 236 of the reflection device 23. The reflected light includes information about the reflection device 23 that is a reflection source. According to the received reflected light, the first optical communication machine 212 acquires information about the reflection device 23 that is the reflection source of the reflected light. The first optical communication machine 212 controls the phased array antenna 211 according to the information about the reflection device 23. As a result, a radio wave toward a communication target (not illustrated) is transmitted from phased array antenna 211 toward the reflection device 23.

The radio wave reflective plate 231 is an active RIS reflective plate. The radio wave reflective plate 231 has a reflection surface 2310. A meta-surface structure is formed on the reflection surface 2310. The meta-surface structure includes a structure in which elements capable of electrically switching phases are disposed in a lattice pattern. By controlling the elements disposed on the reflection surface 2310, the reflection direction of the radio wave can be controlled. The reflection direction of light by the elements disposed on the reflection surface 2310 can be adaptively changed according to the control of the second optical communication machine 236. For example, characteristics of the elements disposed on the reflection surface 2310 are held in a nonvolatile memory (not illustrated). As long as power is supplied to the radio wave reflective plate 231, the characteristics of the element held in the nonvolatile memory are maintained. For example, power is supplied to the radio wave reflective plate 231 from the second optical communication machine 236 that generates power in response to receiving the projection light. For example, power is supplied from a power supply (not illustrated) installed in the radio wave reflective plate 231 to the radio wave reflective plate 231. The power supply source to the radio wave reflective plate 231 is not particularly limited. The reflection device 23 is disposed in such a way that the communication device 21 and a communication target (not illustrated) can perform wireless communication via the reflection surface 2310 of the reflection device 23. In the present example embodiment, the communication target of the communication device 21 is not limited. Therefore, the plurality of reflection devices 23 is disposed in various directions in such a way that the communication range of the communication device 21 is wider.

The second optical communication machine 236 includes a light transmitting/receiving face 2360 for transmitting and receiving optical signals. The reflection surface 2310 of the radio wave reflective plate 231 and the light transmitting/receiving face 2360 of the second optical communication machine 236 are directed in the same direction. £ The second optical communication machine 236 receives projection light projected from the first optical communication machine 212 of the communication device 21 on the light transmitting/receiving face 2360. The second optical communication machine 236 includes a solar cell (not illustrated). The solar cell generates power in response to receiving projection light. The second optical communication machine 236 is activated by the power supply related to the power generation of the solar cell. The activated second optical communication machine 236 detects the direction from which the projection light arrives. The second optical communication machine 236 includes a retroreflective plate (not illustrated). A shutter (not illustrated) that opens and closes according to electrical control is installed at the reflection surface of the retroreflective plate. The second optical communication machine 236 controls opening and closing of the shutter according to the opening and closing conditions stored in advance. The opening and closing condition stored in advance corresponds to a pattern for transmitting information about the reflection device 23. The reflected light modulated according to the opening/closing pattern of the shutter is emitted from the second optical communication machine 236 by opening/closing control of the shutter by the second optical communication machine 236. The reflected light emitted from the second optical communication machine 236 travels toward the first optical communication machine 212 that has projected the projection light. The reflected light is received by the first optical communication machine 212.

The second optical communication machine 236 receives request light including a request of the reflection device 23 from the first optical communication machine 212 of the communication device 21. The second optical communication machine 236 controls the elements disposed on the reflection surface 2310 of the radio wave reflective plate 231 according to the request included in the request light. The second optical communication machine 236 controls a phase of an element associated with the communication device 21 among the plurality of elements disposed on the reflection surface 2310 in such a way as to reflect the radio wave from the communication device 21 in a direction according to the request from the communication device 21.

Further, the second optical communication machine 236 receives information light including information about a communication target (not illustrated) of the communication device 21 from the first optical communication machine 212 of the communication device 21. The second optical communication machine 236 controls a phase of an element associated with the communication device 21 among the plurality of elements disposed on the reflection surface 2310 in such a way as to reflect the radio wave from the communication device 21 toward the communication target according to the information about the communication target included in the information light. The second optical communication machine 236 stores information about a communication target.

### Second Optical Communication Machine

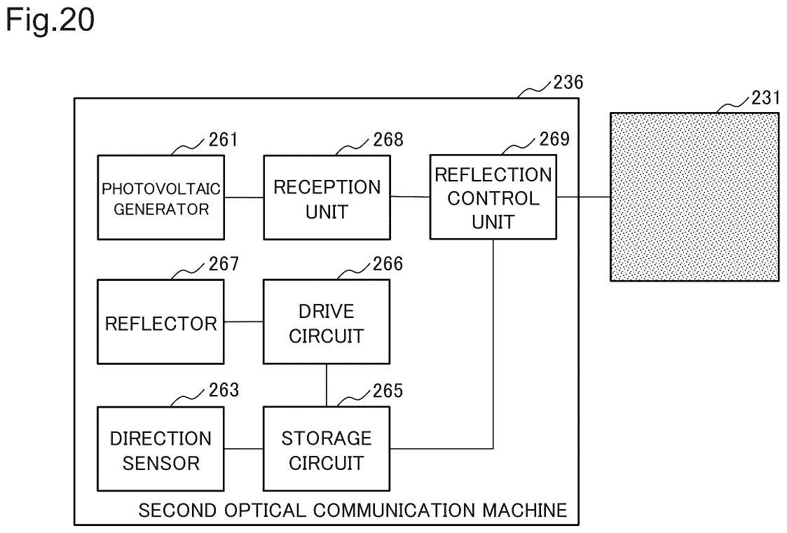

FIG. 20 is a conceptual diagram illustrating an example of a configuration of the second optical communication machine 236 included in the reflection device 23. The second optical communication machine 236 includes a photovoltaic generator 261, a direction sensor 263, a storage circuit 265, a drive circuit 266, a reflector 267, a reception unit 268, and a reflection control unit 269. For example, the second optical communication machine 236 is configured to drive with power of several hundred microwatts (μW) to about 10 milliwatts (mW) generated by the photovoltaic generator 261.

The photovoltaic generator 261 has a configuration similar to that of the photovoltaic generator 161 of the first example embodiment. The photovoltaic generator 261 receives projection light projected from the communication device 21. The photovoltaic generator 261 generates power by the received projection light. The photovoltaic generator 261 supplies the generated power to the direction sensor 263, the storage circuit 265, the drive circuit 266, the reflector 267, the reception unit 268, and the reflection control unit 269.

The photovoltaic generator 261 generates an electric signal related to the pattern of the projection light. For example, the photovoltaic generator 261 includes a light receiving element (not illustrated) that converts light into an electric signal. The light receiving element is achieved by an element similar to the light receiving element 152 of the first example embodiment. The photovoltaic generator 261 outputs an electric signal related to the pattern of the projection light to the reception unit 268.

The direction sensor 263 has a configuration similar to that of the direction sensor 263 of the first example embodiment. The direction sensor 263 receives projection light projected from the communication device 21. The direction sensor 263 detects a direction from which the received projection light arrives. The direction sensor 263 stores direction data related to the detected direction in the storage circuit 265.

The storage circuit 265 is a storage device that stores data. For example, the storage circuit 265 is achieved by a storage device such as a memory or a register. The storage circuit 265 stores data (also referred to as device data) related to the reflection device 23. The device data related to the reflection device 23 includes an identifier (ID) of the reflection device 23, position information related to a position where the reflection device 23 is disposed, performance of the radio wave reflective plate 231 (RIS reflective plate) of the reflection device 23, and the like. The device data is stored in advance in the storage circuit 265. For example, the device data related to the reflection device 23 is set in a transmission data register (not illustrated) in response to activation of the second optical communication machine 236 by reception of the projection light. The transmission data register temporarily stores data (also referred to as transmission data) to be transmitted toward the communication device 21.

The direction data of the communication device 21 is written in the storage circuit 265. The direction data of the communication device 21 corresponds to the direction of the reflection surface 2310 of the reflection device 23 with respect to the transmission/reception face 2110 of the phased array antenna 211 of the communication device 21. The direction data includes the first direction data (X coordinate) and the second direction data (Y coordinate) detected by the direction sensor 263. For example, the direction data indicating the direction (position) of the reflection device 23 is added to the device data related to the reflection device 23. For example, the direction data is added to the device data set in the data register. Data including the device data and the direction data is transmission data. The transmission data is generated in association with the communication device 21. The transmission data is referred to by the drive circuit 266.

The drive circuit 266 has a configuration similar to that of the drive circuit 166 of the first example embodiment. The drive circuit 266 acquires the transmission data stored in the storage circuit 265. The drive circuit 266 controls the reflector 267 according to the acquired pattern of the transmission data.

The reflector 267 has a configuration similar to that of the reflector 167 of the first example embodiment. The reflector 267 includes a retroreflective plate that retroreflects light. An electrically controllable shutter (not illustrated) is disposed on the incident face side of the retroreflective plate. The shutter is opened and closed in accordance with driving of the drive circuit 266. An opening/closing pattern related to the pattern of the transmission data is set to the shutter. The reflected light is modulated by opening and closing the shutter with an opening/closing pattern according to the pattern of the transmission data. As a result, the reflected light of the blinking pattern related to the transmission data is emitted. The modulated reflected light travels toward the communication device 21 (first optical communication machine 212) that is the projection source of the projection light along the incidence direction of the projection light.

The reception unit 268 acquires an electric signal related to the pattern of the projection light from the photovoltaic generator 261. When the received pattern does not have a constant cycle, the reception unit 268 outputs the electric signal to the reflection control unit 269. When the received pattern has a constant cycle, the projection light on which the pattern is based is the search light. For the search light, the second optical communication machine 236 may cause the shutter of the reflector 267 to transmit the reflected light back to the communication device 11 that is the projection source of the search light. When the received pattern does not have a constant cycle, the projection light on which the pattern is based is the request light or the information light. The second optical communication machine 236 controls the element of the reflection surface 2310 of the radio wave reflective plate 231 in such a way as to have reflection characteristics related to the request light and the information light with respect to the request light and the information light.

When receiving the reflected light, the first optical communication machine 212 converts the reflected light into digital data. The first optical communication machine 212 acquires device data related to the reflection device 23 in which the second optical communication machine 236 is installed according to the pattern of the converted digital data. For example, the first optical communication machine 212 acquires an identifier (ID) of the reflection device 23, position information about a position where the reflection device 13 is disposed, and device data regarding performance of the radio wave reflective plate 231 (RIS reflective plate) of the reflection device 23 and the like. The first optical communication machine 212 acquires direction data regarding the direction of the reflection surface 2310 of the radio wave reflective plate 231 of the reflection device 23. The communication device 21 searches for a communication target using the reflection device 23 according to the acquired device data and direction data.

The first optical communication machine 212 projects request light for requesting a search for a communication target toward the second optical communication machine 236 of the reflection device 23 according to the acquired transmission data. The request light includes a request for changing the reflection direction on the reflection surface 2310 of the radio wave reflective plate 231 included in the reflection device 23 in order for the communication device 21 to search for a communication target.

When communication with the communication target is established, the first optical communication machine 212 projects information light including information about the communication target toward the second optical communication machine 236 of the reflection device 23. The information light includes information about control of the reflection surface 2310 of the radio wave reflective plate 231 included in the reflection device 23 in communication between the detected communication target and the communication device 11. That is, the information light includes information about a reflection characteristic of the reflection surface 2310 in communication between the communication target and the communication device 11. When the radio wave reflective plate 231 of the reflection device 23 is installed with a reflection characteristic related to information light, communication between the communication device 11 and a communication target is established.

When communication between the communication device 11 and the communication target is established, the communication device 11 starts wireless communication using the reflection device 23. Communication with the communication target may be interrupted according to a change in a positional relationship between the communication device 21 and the communication target. In such a case, the communication device 21 searches for the reflection device 23 capable of communicating with the communication target at the timing when the communication is interrupted or at the timing when the communication is predicted to be interrupted. When the reflection device 23 capable of communicating with the communication target is searched for, the communication device 21 switches to communication using the reflection device 23. By repeating these processes, the communication device 21 can continue communication with the communication target.

### Operation

Next, an operation of the communication system 2 will be described with reference to the drawings. Hereinafter, individual operations of the communication device 21 and the reflection device 23 will be described.

### Communication Device

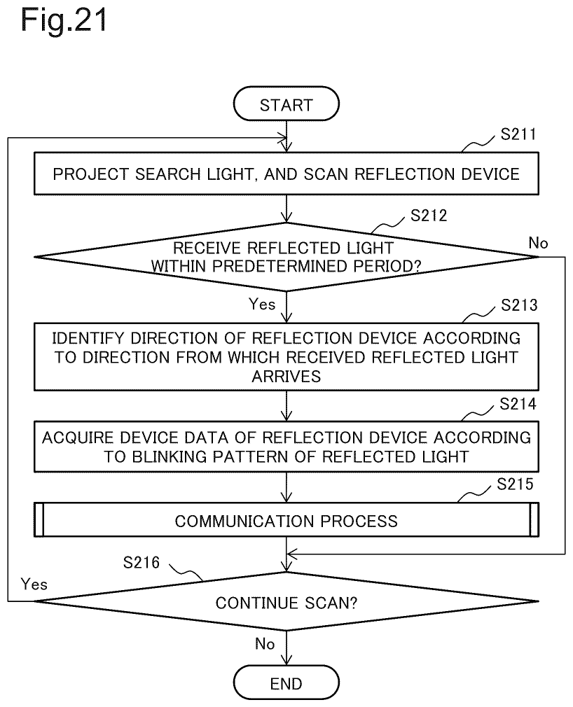

FIG. 21 is a flowchart for describing the operation of the communication device 21. In the description of the process along the flowchart of FIG. 21, the communication device 21 will be described as an operation subject. For example, the process along the flowchart of FIG. 21 is executed in a case where the communication device 21 or the reflection device 23 is newly installed. The process along the flowchart of FIG. 21 may be executed for each search for a communication target by the communication device 21.

In FIG. 21, first, the communication device 21 projects search light and scans the reflection device 23 (step S211). The communication device 21 projects search light from the first optical communication machine 212. The communication device 21 scans the reflection device 23 located inside the coverage of the radio wave radiated from the phased array antenna 211.

When the reflected light is received within the predetermined period (Yes in step S212), the communication device 21 identifies the direction of the reflection device 23 according to the direction from which the received reflected light arrives (step S213). The predetermined period is a period set in a single projection direction or a single projection range. The predetermined period is a preset period. When the reflected light is not received within the predetermined period (No in step S212), the process proceeds to step S216.

After step S213, the communication device 21 acquires the transmission data of the reflection device 23 according to the blinking pattern of the reflected light (step S214). The communication device 21 acquires the transmission data of the reflection device 23 based on the pattern of the digital data according to the blinking pattern of the reflected light.

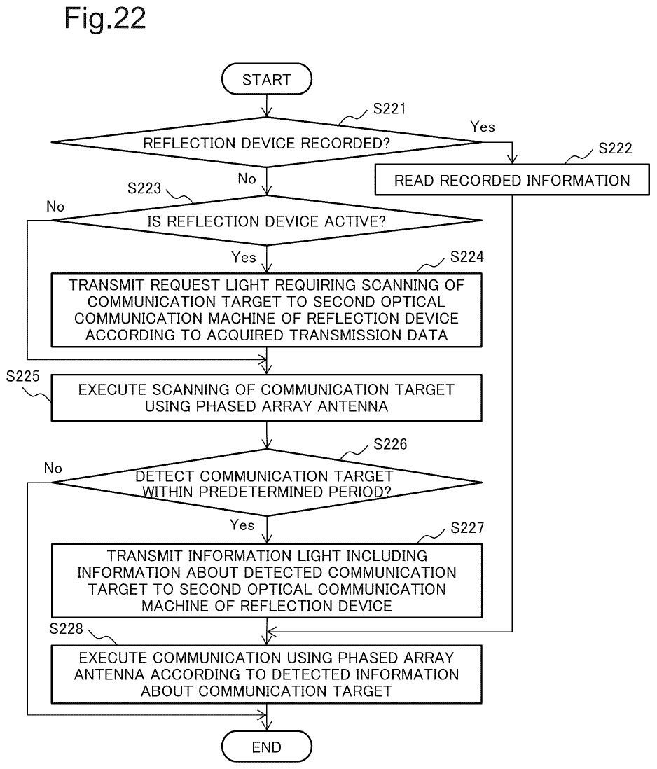

Next, the communication device 21 executes a communication process according to the acquired transmission data (step S215). The communication process in step S215 will be described later (FIG. 22).

After step S216 or when No in step S212, the communication device 21 determines whether to continue scanning the reflection device 23 (step S216). When scanning is continued (Yes in step S216), the process returns to step S211. When the scanning is ended (No in step S216), the process along the flowchart of FIG. 21 is ended. Conditions for continuation/termination of scanning may be set in advance.

### Communication Process

Next, the communication process in step S215 in FIG. 21 will be described with reference to the drawings. FIG. 22 is a flowchart for describing the communication process. In the following description of the communication process, the communication device 21 will be described as an operation subject.

In FIG. 22, first, the communication device 21 determines whether the reflection device 23 that is the reflection source of the reflected light has been recorded (step S221). When the reflection device 23 has been recorded (Yes in step S221), the recorded information is read (step S222). After step S111, the process proceeds to step S228.

On the other hand, when the reflection device 23 has not been recorded (No in step S221), the communication device 21 determines whether the reflection device 23 actively operates based on the device data of the reflection device 23 (step S223). In a case where all the reflection devices 23 constituting the communication system 2 operate actively, step S223 can be omitted.

In a case where the reflection device 23 operates actively (Yes in step S223), the communication device 21 projects request light for requesting scanning of the communication target to the second optical communication machine 236 of the reflection device 23 according to the acquired transmission data (step S224). When reflection device 23 is passive (No in step S223), the process proceeds to step S225.

After step S224 or when No in step S223, the communication device 21 executes scanning of the communication target using the phased array antenna 211 (step S225). During the period in which the scanning of the communication target is being executed, the reflection direction of the radio wave transmitted from the communication device 21 is changed by the reflection device 23 according to the request light from the communication device 21.

When the communication target is detected within the predetermined period (Yes in step S226), the communication device 21 projects information light including information about the detected communication target to the second optical communication machine 236 of the reflection device 23 (step S227). When the communication target has not been detected within the predetermined period (No in step S226), the process according to the flowchart in FIG. 22 ends (the process proceeds to step S216 in FIG. 21).

After step S222 or step S227, the communication device 21 executes communication using the phased array antenna 211 according to the detected information about the communication target (step S228). As the communication using the phased array antenna 211, the communication device 21 executes allocation of an antenna unit to the reflection device 23, search for a communication target, establishment of communication with the searched communication target, and communication with the established communication target. After step S228, the process proceeds to step S216 in FIG. 21.

### Reflection Device

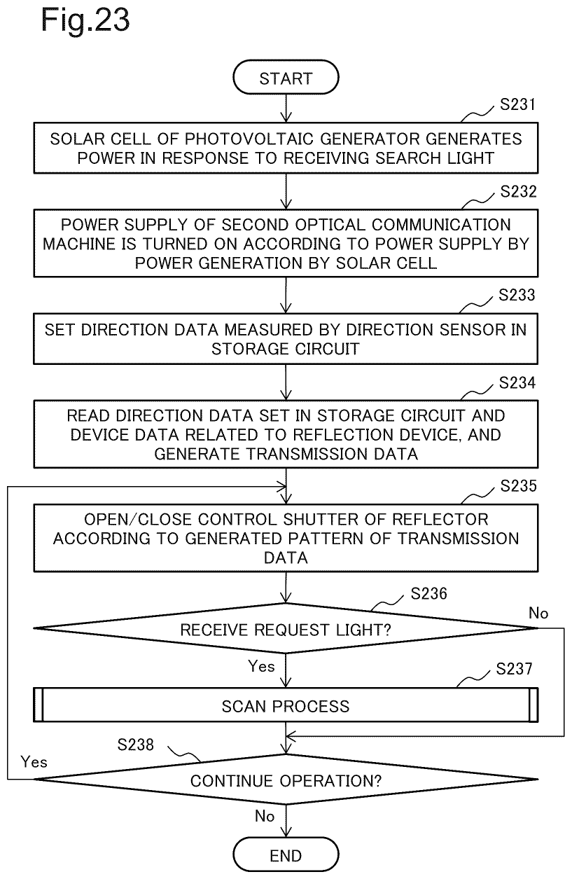

Next, the operation of the reflection device 23 will be described with reference to the drawings. FIG. 23 is a flowchart for describing the operation of the reflection device 23. In the description of the process along the flowchart of FIG. 23, the second optical communication machine 236 included in the reflection device 23 will be described as the operation subject. The processing of the flowchart of FIG. 23 also includes power generation of the solar cell of the photovoltaic generator 261 included in the second optical communication machine 236 of the reflection device 23, activation of the second optical communication machine 236 according to power supply by the solar cell, and the like.

In FIG. 23, first, in response to receiving the projection light from the first optical communication machine 212 of the communication device 21, the solar cell of the photovoltaic generator 261 included in the second optical communication machine 236 of the reflection device 23 starts power generation (step S231).

Next, the power of the second optical communication machine 236 is turned on according to the power supply by the power generation of the solar cell (step S232). Before the projection light is received, the first optical communication machine 212 may be activated according to the power generation of the solar cell of the photovoltaic generator 261 by the ambient light. Since the arrival direction of the ambient light is not constant and is not patterned at a constant cycle, the ambient light can be distinguished from the projection light.

Next, the second optical communication machine 236 sets direction data measured by the direction sensor 263 in the storage circuit 265 (step S233). The second optical communication machine 236 may set direction data in a transmission data register (not illustrated).

Next, the second optical communication machine 236 reads the direction data set in the storage circuit 265 and the device data related to the reflection device 23 from the storage circuit 265, and generates transmission data (step S234). The transmission data includes direction data and device data.

Next, the second optical communication machine 236 performs opening/closing control of the shutter of the reflector 267 according to the generated pattern of the transmission data (step S235). In accordance with the opening/closing control of the shutter of the reflector 267, the reflected light modulated according to the device data of the reflection device 23 is emitted toward the first optical communication machine 212 of the communication device 21.

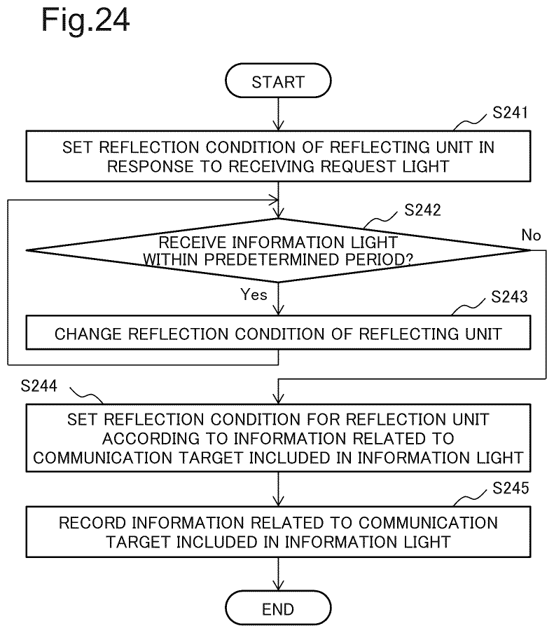

When the request light is received (Yes in step S236), the second optical communication machine 236 executes a scan process (step S237). The scan process in step S237 will be described later (FIG. 24). When the request light is not received (No in step S236), the process proceeds to step S238.

After step S237 or when No in step S236, the second optical communication machine 236 determines continuation of the operation (step S238). When the operation is continued (Yes in step S238), the process returns to step S235. When the operation is ended (No in step S238), the process along the flowchart of FIG. 23 is ended. The determination criterion for continuation of the operation may be set in advance. For example, the second optical communication machine 236 terminates the operation in response to receiving the information light from the communication device 21. For example, the operation of the second optical communication machine 236 ends at the timing when the projection of the projection light by the communication device 21 ends and the power generation by the solar cell ends.

### <Scan Process>

Next, the communication process in step S237 in FIG. 23 will be described with reference to the drawings. FIG. 24 is a flowchart for describing a scan process. In the following description of the communication process, the second optical communication machine 136 will be described as an operation subject.

In FIG. 24, first, the second optical communication machine 236 sets the reflection condition of the radio wave reflective plate 231 in response to receiving the request light (step S241).

When the information light is received within the predetermined period (Yes in step S242), the second optical communication machine 236 changes the reflection condition of the radio wave reflective plate 231 (step S243). For example, the second optical communication machine 236 changes the reflection direction by the radio wave reflective plate 231 according to a preset order. After step S243, the process returns to step S242.

On the other hand, when the information light is not received within the predetermined period (No in step S242), the second optical communication machine 236 sets the reflection condition of the radio wave reflective plate 231 according to the information about the communication target included in the information light (step S244).

Next, the second optical communication machine 236 records information about the communication target included in the information light (step S245). After step S245, the process proceeds to step S238 in FIG. 23.

### Application Example

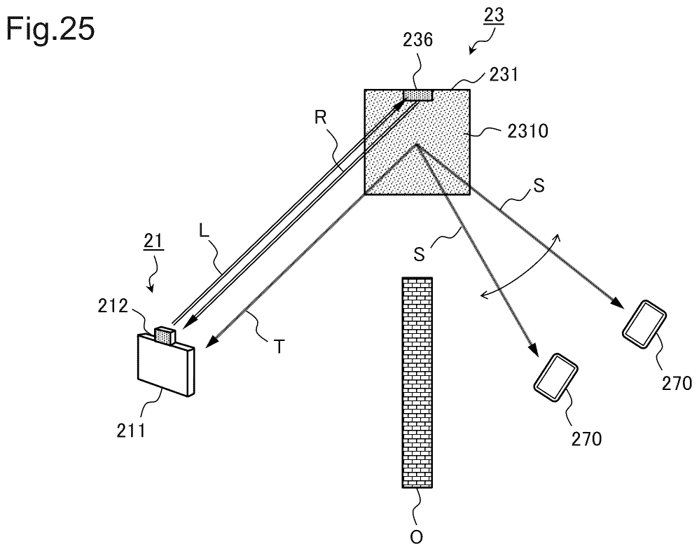

Next, an application example of the communication system 2 of the present example embodiment will be described with reference to the drawings. FIGS. 25 to 27 are conceptual diagrams for describing an application example of the communication system 2 of the present example embodiment.

### Application Example 1

FIG. 25 illustrates an example (Application Example 1) in which an obstacle O is interposed between the communication device 21 and a communication terminal 270 with which the communication device 21 is to be communicated. In Application Example 1, since the obstacle O is interposed, the communication device 21 cannot directly transmit a radio wave to the communication terminal 270.

In FIG. 25, the communication device 21 projects the projection light L from the first optical communication machine 212. The second optical communication machine 236 of the reflection device 23 receives the projection light L projected by the communication device 21. The second optical communication machine 236 is activated in response to receiving the projection light L. The activated second optical communication machine 236 detects the direction from which the projection light L arrives. The second optical communication machine 236 controls opening and closing of the shutter of the reflector 267 according to the transmission data of the reflection device 23 to modulate the reflected light R.

In response to receiving the reflected light R modulated in accordance with the transmission data, the communication device 21 projects, from the first optical communication machine 212, request light for requesting scanning of the communication terminal 270 to be communicated with. The communication device 21 transmits the radio signal S from the phased array antenna 211 toward the reflection surface 2310 of the radio wave reflective plate 231 of the reflection device 23. The radio signal S transmitted from phased array antenna 211 travels toward the reflection surface 2310 of the reflection device 23. The radio signal S is reflected by the reflection surface 2310 of the reflection device 23 in the scan operation according to the request light. The radio signal S transmitted from the communication device 21 is reflected by the reflection surface 2310 of the reflection device 23 in the scan operation, and the reflection direction is controlled.

In the example of FIG. 25, two communication terminals 270 are located within the scan range of the reflection device 23. The communication terminal 270 that has received the radio signal S reflected by the reflection surface 2310 of the reflection device 23 transmits a response signal T toward the direction from which the radio signal S arrives. The response signal T is reflected by the reflection surface 2310 of the reflection device 23 and received by the phased array antenna 211 of the communication device 21 that is the transmission source of the radio signal S. The communication device 21 that has received the response signal T acquires information about the communication terminal 270 that is the transmission source of the response signal T. The communication device 21 projects information light related to the communication terminal 270 that is the transmission source of the response signal T from the first optical communication machine 212 toward the second optical communication machine 236 of the reflection device 23. The reflection device 23 receives information light using the second optical communication machine 236. The reflection device 23 sets a reflection condition of the radio wave reflective plate 231 of the reflection device 23 according to the received information light. When setting related to the information light is performed on the radio wave reflective plate 231 of the reflection device 23, communication is established between the communication terminal 270 that is the transmission source of the response signal T and the communication device 21.

### Application Example 2

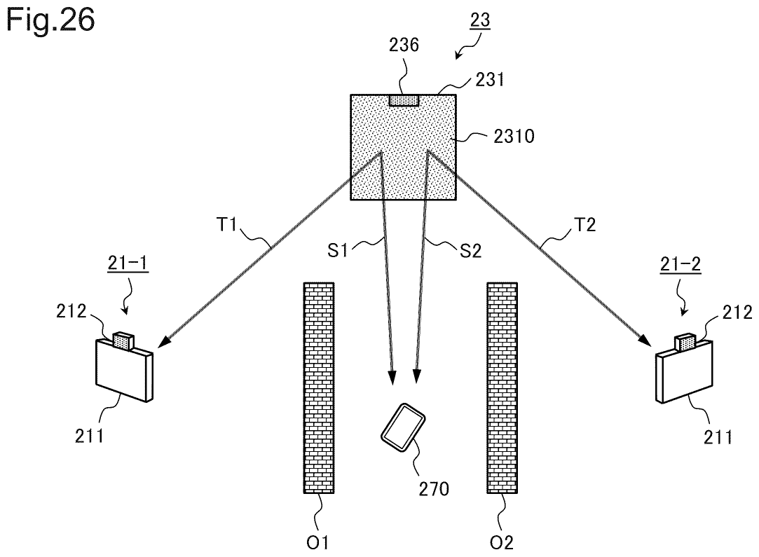

FIG. 26 illustrates an example in which two communication devices 21-1 to 2 share the reflection device 23. An obstacle O1 is interposed between the communication device 21-1 and the communication terminal 270 with which that the communication device 21-1 is to be communicated. An obstacle O2 is interposed between the communication device 21-2 and the communication terminal 270 with which the communication device 21-2 is to be communicated. In Application Example 2, since the obstacle O1 and the obstacle O2 are interposed, the communication devices 21-1 to 2 cannot directly transmit radio waves to the communication terminal 270. In the example of FIG. 26, exchange of the projection light and the reflected light is omitted. As in Application Example 1, the communication devices 21-1 to 2 scan the communication terminal 270 using the radio wave reflective plate 231 of the reflection device 23.

In response to receiving the reflected light modulated by the reflection device 23, the communication device 21-1 projects, from the first optical communication machine 212, request light for requesting scanning of the communication terminal 270 to be communicated with. The communication device 21-1 transmits a radio signal S1 from the phased array antenna 211 toward the reflection surface 2310 of the radio wave reflective plate 231 of the reflection device 23. The radio signal S1 transmitted from phased array antenna 211 of communication device 21-1 travels toward the reflection surface 2310 of radio wave reflective plate 231 of the reflection device 23. Part (reflection region A) of the reflection surface 2310 of the reflection device 23 is allocated to the communication device 21-1. The radio signal S1 is reflected by the reflection surface 2310 (reflection region A) of the reflection device 23 in the scan operation. The radio signal SI transmitted from the communication device 21-1 is reflected by the reflection surface 2310 (reflection region A) during the scan operation, and the reflection direction is controlled.

The communication terminal 270 that has received the radio signal S1 reflected by the reflection surface 2310 (reflection region A) of the reflection device 23 transmits a response signal Tl toward the direction from which the radio signal S1 arrives. The response signal Tl is reflected by the reflection surface 2310 (reflection region A) of the reflection device 23 and received by the phased array antenna 211 of the communication device 21-1 that is the transmission source of the radio signal S1. The communication device 21-1 that has received the response signal T1 acquires information about the communication terminal 270 that is the transmission source of the response signal T1. The communication device 21-1 projects information light related to the communication terminal 270 that is the transmission source of the response signal T1 from the first optical communication machine 212 toward the second optical communication machine 236 of the reflection device 23. The reflection device 23 receives information light projected from the first optical communication machine 212. The reflection device 23 sets a reflection condition on the reflection surface 2310 (reflection region A) of the reflection device 23 according to the received information light. When the setting related to the information light is performed on the reflection surface 2310 (reflection region A) of the reflection device 23, communication is established between the communication terminal 270 that is the transmission source of the response signal T1 and the communication device 21-1.

In response to receiving the reflected light modulated by the reflection device 23, the communication device 21-2 projects, from the first optical communication machine 212, request light for requesting scanning of the communication terminal 270 to be communicated with. The communication device 21-2 transmits a radio signal S2 from the phased array antenna 211 toward the reflection surface 2310 of the radio wave reflective plate 231 of the reflection device 23. The radio signal S2 transmitted from phased array antenna 211 of communication device 21-2 travels toward the reflection surface 2310 of radio wave reflective plate 231 of the reflection device 23. Part (reflection region B) of the reflection surface 2310 of the reflection device 23 is allocated to the communication device 21-2. The radio signal S2 is reflected by the reflection surface 2310 (reflection region B) of the reflection device 23 in the scan operation. The radio signal S2 transmitted from the communication device 21-2 is reflected by the reflection surface 2310 (reflection region B) during the scan operation, and the reflection direction is controlled.

The communication terminal 270 that has received the radio signal S2 reflected by the reflection surface 2310 (reflection region B) of the reflection device 23 transmits a response signal T2 toward the direction from which the radio signal S2 arrives. The response signal T2 is reflected by the reflection surface 2310 (reflection region B) of the reflection device 23 and received by the phased array antenna 211 of the communication device 21-2 that is the transmission source of the radio signal S2. The communication device 21-2 that has received the response signal T2 acquires information about the communication terminal 270 that is the transmission source of the response signal T2. The communication device 21-2 projects information light related to the communication terminal 270 that is the transmission source of the response signal T2 from the first optical communication machine 212 toward the second optical communication machine 236 of the reflection device 23. The reflection device 23 receives information light projected from the first optical communication machine 212. The reflection device 23 sets a reflection condition on the reflection surface 2310 (reflection region B) of the reflection device 23 according to the received information light. When the setting related to the information light is performed on the reflection surface 2310 (reflection region B) of the reflection device 23, communication is established between the communication terminal 270 that is the transmission source of the response signal T2 and the communication device 21-2.

### Application Example 3

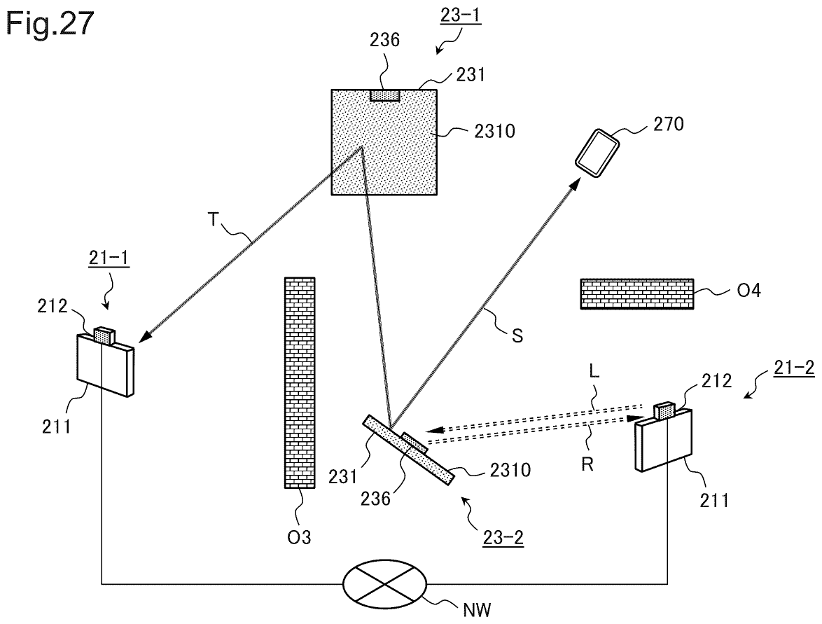

FIG. 27 illustrates an example in which the two communication devices 21-1 to 2 cooperate with each other, and communication between the communication device 21-1 and the communication terminal 270 is established via the two reflection devices 23-1 to 2. The two communication devices 21-1 to 2 are connected via a network NW. An obstacle O3 is interposed in a communication path between the communication device 21-1 and the communication terminal 270 that is a communication target of the communication device 21-1. An obstacle O4 is interposed between the communication device 21-2 and the communication terminal 270. In Application Example 3, since the obstacle O3 and the obstacle O4 are interposed, the communication devices 21-1 to 2 cannot directly transmit radio waves to the communication terminal 270. In the example of FIG. 27, transmission and reception of the projection light and the reflected light may be omitted. The communication device 21-1 scans the communication terminal 270 using the radio wave reflective plate 231 of the reflection devices 23-1 to 2. In FIG. 27, it is assumed that the search for the reflection device 23-1 by the communication device 21-1 has already been completed.

In FIG. 27, the first optical communication machine 212 of the communication device 21-2 projects the projection light L toward the second optical communication machine 236 of the reflection device 23-2. The second optical communication machine 236 of the reflection device 23-2 receives the projection light L projected by the communication device 21-2. The second optical communication machine 236 of the communication device 21-2 is activated in response to receiving the projection light L. The activated second optical communication machine 236 detects the direction from which the projection light L arrives. The second optical communication machine 236 controls opening and closing of the shutter of the reflector 267 in a pattern according to the transmission data of the reflection device 23-2 to modulate the reflected light R. The communication device 21-2 acquires the transmission data of the reflection device 23-2 in response to receiving the modulated reflected light R. The communication device 21-2 transmits the acquired transmission data of the reflection device 23-2 to the communication device 21-1 via the network NW. The communication device 21-1 acquires information about the reflection device 23-2 via the network NW. The communication device 21-1 indirectly acquires information about the reflection device 23-2 from the communication device 21-2.

In response to receiving the reflected light modulated by the reflection device 23-1, the communication device 21-1 causes the first optical communication machine 212 to project request light for requesting scanning of the communication terminal 270 to be communicated with. The communication device 21-1 transmits the radio signal S from the phased array antenna 211 toward the reflection surface 2310 of the radio wave reflective plate 231 of the reflection device 23-1. The radio signal S transmitted from the phased array antenna 211 of the communication device 21-1 travels toward the reflection surface 2310 of the reflection device 23-1. The reflection device 23-1 receives the request light from the communication device 21-1. In response to the request light from the communication device 21-1, part of the reflection surface 2310 of the reflection device 23-1 is allocated to the communication device 21-1. The radio signal S is reflected by the reflection surface 2310 during the scan operation. The radio signal S transmitted from the communication device 21-1 is reflected by the reflection surface 2310 during the scan operation, and the reflection direction is controlled. In the case of the example of FIG. 27, the radio signal S transmitted from the communication device 21-1 is reflected by the reflection surface 2310 of the reflection device 23-1 during the scan operation, and travels toward the reflection surface 2310 of the reflection device 23-2.

The communication device 21-1 transmits a signal (also referred to as a request signal) including a request for scanning of the communication terminal 270 to be communicated with to the communication device 21-2 via the network NW. The communication device 21-2 projects the request light related to the request signal from the communication device 21-1 toward the second optical communication machine 236 of the reflection device 23-2. In response to the request light from the communication device 21-2, part of the reflection surface 2310 of the reflection device 23-2 is allocated to the communication device 21-1. The radio signal S reflected by the reflection surface 2310 of the reflection device 23-1 is reflected by the reflection surface 2310 of the reflection device 23-2 during the scan operation. The reflection devices 23-1 to 2 may simultaneously execute the scan operation, or either one of them may execute the scan operation. The radio signal S reflected by the reflection surface 2310 of the reflection device 23-1 is reflected by the reflection surface 2310 of the reflection device 23-2, and the reflection direction is controlled.

The communication terminal 270 that has received the radio signal S reflected by the reflection surface 2310 of the reflection device 23-2 transmits the response signal T toward the direction from which the radio signal S arrives. The response signal T is reflected by the reflection surface 2310 of the reflection device 23-2 and travels toward the reflection surface 2310 of the reflection device 23-1. The response signal T traveling toward the reflection surface 2310 of the reflection device 23-1 is reflected by the reflection surface 2310 and received by the phased array antenna 211 of the communication device 21-1 that is the transmission source of the radio signal S. The communication device 21-1 that has received the response signal T acquires information about the communication terminal 270 that is the transmission source of the response signal T.

The communication device 21-1 projects information light related to the communication terminal 270 that is the transmission source of the response signal T from the first optical communication machine 212 toward the second optical communication machine 236 of the reflection device 23-1. The reflection device 23-1 sets a reflection condition on the reflection surface 2310 of the reflection device 23-1 according to the received information light. The communication device 21-1 transmits an information signal including information about the communication terminal 270 that is the transmission source of the response signal T to the communication device 21-2 via the network NW. The communication device 21-2 projects information light related to an information signal toward the second optical communication machine 236 of the reflection device 23-2 using the first optical communication machine 212. The reflection device 23-2 sets a reflection condition on the reflection surface 2310 of the reflection device 23-2 according to the received information light. When setting according to the information light related to the communication target of the communication device 21-1 is performed on the reflection surfaces 2310 of the reflection devices 23-1 to 2, communication is established between the communication terminal 270 that is the transmission source of the response signal T and the communication device 21-1.

As described above, the communication system of the present example embodiment includes the communication device and the plurality of reflection devices. The communication device includes the phased array antenna and the first optical communication machine. The reflection device includes a radio wave reflection corpus and a second optical communication machine. The reflection direction of the radio wave reflective plate is dynamically controlled according to the control of the second optical communication machine.

The phased array antennas transmit beamformed radio waves. The first optical communication machine is associated with the phased array antenna. The first optical communication machine projects projection light toward the second optical communication machine associated with the radio wave reflective plate. The first optical communication machine acquires transmission data related to the radio wave reflective plate according to the pattern of the reflected light from the second optical communication machine. The first optical communication machine projects, in response to receiving the reflected light, request light for requesting a scan operation for dynamically changing the reflection direction of the radio wave reflective plate toward the second optical communication machine associated with the reflection device. The first optical communication machine causes the phased array antenna to transmit a radio signal for scanning a communication target of the communication device. In response to reception, by the phased array antenna, of a response signal to a radio wave transmitted from a communication target during a scan operation period, the first optical communication machine acquires information about the communication target included in the response signal. The first optical communication machine projects information light including the acquired information about the communication target toward the second optical communication machine associated with the reflection device. The first optical communication machine controls the phased array antenna according to the information about the communication target included in the response signal.

The radio wave reflective plate has a reflection surface having a meta-surface structure. The second optical communication machine is associated with the radio wave reflective plate. The second optical communication machine is activated in response to receiving projection light projected from the first optical communication machine. The second optical communication machine generates direction data related to a direction from which the projection light arrives. The second optical communication machine retroreflects, toward the first optical communication machine, the reflected light of the projection light modulated in a pattern according to transmission data including the device data and the direction data related to the radio wave reflective plate.

The second optical communication machine executes a scan operation of dynamically changing the reflection direction of the radio wave reflective plate in response to receiving the request light projected from the first optical communication machine associated with the communication device. The second optical communication machine sets the reflection direction of the radio wave reflective plate in response to receiving the information light projected from the first optical communication machine associated with the communication device in such a way as to conform to communication between the communication device and the communication target.

The communication system according to the present example embodiment dynamically controls the reflection direction of the radio wave reflective plate in response to a request from the communication device. According to the present example embodiment, it is possible to keep tracking a communication target according to movement of the communication target of the communication device.

In an aspect of the present example embodiment, the plurality of communication devices shares the radio wave reflective plate of the reflection device. According to the present aspect, a plurality of communication devices can communicate with a communication target while sharing a radio wave reflective plate.

In an aspect of the present example embodiment, a plurality of communication devices is connected to be able to cooperate through a network. The plurality of communication devices communicates with a communication target of each of the plurality of communication devices using the plurality of reflection devices. According to the present aspect, communication coverage can be expanded by using a plurality of reflection devices.

### Third Example Embodiment

Next, a communication system according to a third example embodiment will be described with reference to the drawings. The communication system according to the present example embodiment has a configuration in which the communication systems of the first to second example embodiments are simplified.

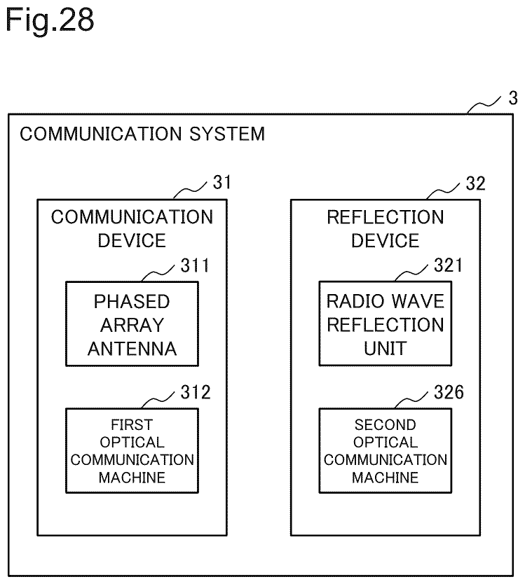

FIG. 28 is a block diagram illustrating an example of a configuration of a communication system 3 according to the present example embodiment. The communication system 3 includes a communication device 31 and a reflection device 32. The communication device 31 includes a phased array antenna 311 and a first optical communication machine 312. The reflection device 32 includes a radio wave reflective plate 321 and a second optical communication machine 326.

Phased array antenna 311 transmits a beamformed radio wave. The first optical communication machine 312 is associated with the phased array antenna 311. The first optical communication machine 312 projects projection light toward the second optical communication machine 326 associated with the radio wave reflective plate 321. The first optical communication machine 312 acquires transmission data related to the radio wave reflective plate 321 according to the pattern of the reflected light from the second optical communication machine 326. The first optical communication machine 312 controls the phased array antenna 311 according to the acquired transmission data.

The radio wave reflective plate 321 has a reflection surface having a meta-surface structure. The second optical communication machine 326 is associated with the radio wave reflective plate 321. The second optical communication machine 326 is activated in response to receiving projection light projected from the first optical communication machine 312. The second optical communication machine 326 generates direction data related to the direction from which the projection light arrives. The second optical communication machine 326 retroreflects, toward the first optical communication machine 312, the reflected light of the projection light modulated in a pattern according to transmission data including the device data and the direction data related to the radio wave reflective plate 321.

The communication system according to the present example embodiment includes a radio wave reflective plate controlled by a second optical communication machine that is activated in response to receiving projection light projected from the first optical communication machine. Therefore, the communication system of the present example embodiment can continuously communicate with a desired communication target even in an environment where power supply is difficult.

### Hardware

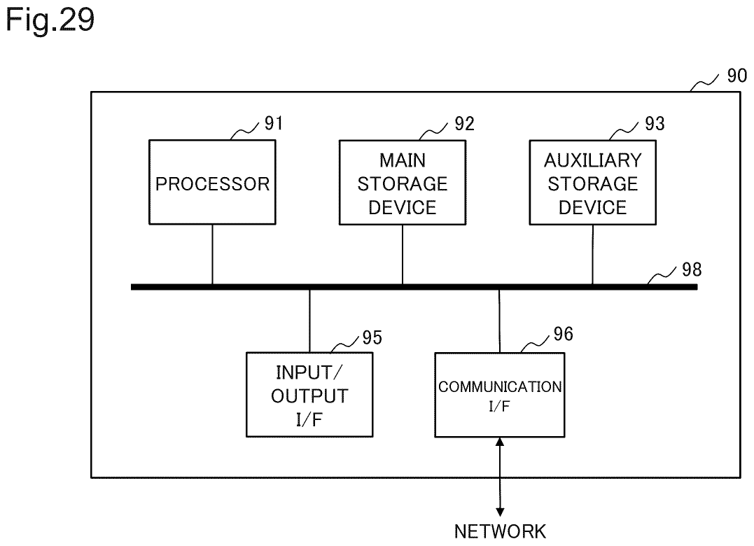

A hardware configuration for executing control and process according to each example embodiment of the present disclosure will be described using an information processing device 90 of FIG. 29 as an example. The information processing device 90 in FIG. 29 is a configuration example for performing control and a process of each example embodiment, and does not limit the scope of the present disclosure.

As illustrated in FIG. 29, the information processing device 90 includes a processor 91, a main storage device 92, an auxiliary storage device 93, an input/output interface 95, and a communication interface 96. In FIG. 29 the interface is abbreviated as an interface (I/F). The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via the communication interface 96.

The processor 91 develops the program stored in the auxiliary storage device 93 or the like in the main storage device 92. The processor 91 executes the program developed in the main storage device 92. In the present example embodiment, a software program installed in the information processing device 90 may be used. The processor 91 executes control and process according to each example embodiment.

The main storage device 92 has an area in which a program is developed. A program stored in the auxiliary storage device 93 or the like is developed in the main storage device 92 by the processor 91. The main storage device 92 is achieved by, for example, a volatile memory such as a dynamic random access memory (DRAM). A nonvolatile memory such as a magnetoresistive random access memory (MRAM) may be configured and added as the main storage device 92.

The auxiliary storage device 93 stores various pieces of data such as programs. The auxiliary storage device 93 is achieved by a local disk such as a hard disk or a flash memory. Various pieces of data may be stored in the main storage device 92, and the auxiliary storage device 93 may be omitted.

The input/output interface 95 is an interface that connects the information processing device 90 with a peripheral device based on a standard or a specification. The communication interface 96 is an interface that connects to an external system or a device through a network such as the Internet or an intranet in accordance with a standard or a specification. The input/output interface 95 and the communication interface 96 may be shared as an interface connected to an external device.

An input device such as a keyboard, a mouse, or a touch panel may be connected to the information processing device 90 as necessary. These input devices are used to input of information and settings. In a case where the touch panel is used as the input device, the display screen of the display device may also serve as the interface of the input device. Data communication between the processor 91 and the input device may be mediated by the input/output interface 95.

The information processing device 90 may be provided with a display device that displays information. In a case where a display device is provided, the information processing device 90 preferably includes a display control device (not illustrated) that controls display of the display device. The display device may be connected to the information processing device 90 via the input/output interface 95.

The information processing device 90 may be provided with a drive device. The drive device mediates reading of data and a program from the recording medium, writing of a processing result of the information processing device 90 to the recording medium, and the like between the processor 91 and the recording medium (program recording medium). The drive device may be connected to the information processing device 90 via the input/output interface 95.

The above is an example of a hardware configuration for enabling control and process according to each example embodiment of the present invention. The hardware configuration of FIG. 29 is an example of a hardware configuration for executing control and process according to each example embodiment, and does not limit the scope of the present invention. A program for causing a computer to execute control and process according to each example embodiment is also included in the scope of the present invention. A program recording medium in which the program according to each example embodiment is recorded is also included in the scope of the present invention. The recording medium can be achieved by, for example, an optical recording medium such as a compact disc (CD) or a digital versatile disc (DVD). The recording medium may be achieved by a semiconductor recording medium such as a universal serial bus (USB) memory or a secure digital (SD) card. The recording medium may be achieved by a magnetic recording medium such as a flexible disk, or another recording medium. In a case where the program executed by the processor is recorded in the recording medium, the recording medium corresponds to a program recording medium.

The components of each example embodiment may be combined in any manner. The components of each example embodiment may be achieved by software or may be achieved by a circuit.

While the present invention is described with reference to example embodiments thereof, the present invention is not limited to these example embodiments. Various modifications that can be understood by those of ordinary skill in the art can be made to the configuration and details of the present invention within the scope of the present invention.

### REFERENCE SIGNS LIST

1,2 communication system
11, 21 communication device
13, 23 reflection device
111, 211 phased array antenna
112, 212 first optical communication machine
121 controller
124 projector
125 light receiver
131, 231 radio wave reflective plate
136, 236 second optical communication machine
141 light source
143 spatial light modulator
145 curved face mirror
147 projection control unit
151 condenser lens
152 light receiving element
153 frequency filter
155 low-pass filter
157 conversion unit
161, 261 photovoltaic generator
163, 263 direction sensor
165, 265 storage circuit
166, 266 drive circuit
167, 267 reflector
1611 solar cell
268 reception unit
269 reflection control unit
1613 regulator
1615 capacitor
1631 first condenser lens
1632 first direction sensor
1633 second condenser lens
1634 second direction sensor
1671 shutter
1672 liquid crystal layer
1673 transparent substrate
1674 polarizing plate
1676 shutter
1677 liquid crystal film
1678 transparent substrate
1679 retroreflective plate

What is claimed is:

1. A communication system comprising:
a communication device including a phased array antenna that transmits a beamformed radio wave and a first optical communication machine associated with the phased array antenna; and
a reflection device including a radio wave reflective plate having a reflection surface of a meta-surface structure, and a second optical communication machine associated with the radio wave reflective plate, wherein
the first optical communication machine is configured to
project projection light toward the second optical communication machine associated with the radio wave reflective plate,
the second optical communication machine is configured to
be activated in response to receiving the projection light projected from the first optical communication machine,
generate direction data according to a direction from which the projection light arrives, and
retroreflect reflected light of the projection light modulated in a pattern according to transmission data including device data related to the radio wave reflective plate and the direction data toward the first optical communication machine,
the first optical communication machine is configured to
acquire the transmission data related to the radio wave reflective plate according to a pattern of the reflected light from the second optical communication machine, and
control the phased array antenna according to the acquired transmission data.

2. The communication system according to claim 1, wherein
the first optical communication machine includes
a projector that projects the projection light,
a light receiver that receives the reflected light from the second optical communication machine and generates digital data related to a pattern of the received reflected light, and
a controller configured to cause the projector to project the projection light, acquire the transmission data related to the radio wave reflective plate from the digital data generated by the light receiver, and cause the phased array antenna to transmit the radio wave toward the radio wave reflective plate according to the acquired transmission data.

3. The communication system according to claim 1, wherein
the second optical communication machine includes
a storage circuit that stores the device data related to the associated radio wave reflective plate,
a photovoltaic generator that generates power in response to receiving the projection light,
a direction sensor that detects a direction from which the projection light arrives and stores the direction data related to the detected direction in the storage circuit,
a reflector including a retroreflective plate including a reflection surface that retroreflects the projection light and a shutter that is opened and closed by electrical control, and
a drive circuit configured to generate transmission data including the device data and the direction data that are stored in the storage circuit, and open and close the shutter in a pattern according to the generated transmission data.

4. The communication system according to claim 3, wherein
the first optical communication machine is configured to
project the projection light modulated in a pattern of a constant cycle, and
the second optical communication machine is configured to
open and close the shutter in a pattern according to the transmission data to reflect the reflected light modulated in the pattern according to the transmission data.

5. The communication system according to claim 3, wherein
the direction sensor includes
a first direction sensor including a plurality of strip-shaped first optical sensors each having a major axis along a first direction, the first direction sensor having a structure in which the plurality of first optical sensors is disposed along a second direction orthogonal to the first direction,
a first condenser lens configured to condense the projection light to at least any one of the plurality of first optical sensors included in the first direction sensor according to a direction from which the projection light arrives,
a second direction sensor including a plurality of strip-shaped second optical sensors each having a major axis along the second direction, the second direction sensor having a structure in which the plurality of second optical sensors is disposed along the first direction, and
a second condenser lens configured to condense the projection light to at least any one of the plurality of second optical sensors included in the second direction sensor according to a direction from which the projection light arrives.

6. The communication system according to claim 1, wherein
a reflection direction of the radio wave reflective plate is dynamically controlled according to control of the second optical communication machine,
the first optical communication machine is configured to
project request light for requesting a scan operation for dynamically changing a reflection direction of the radio wave reflective plate in response to receiving the reflected light toward the second optical communication machine associated with the reflection device, and
transmit, from the phased array antenna, a radio signal for scanning a communication target with which the communication device is to communicate,
the second optical communication machine is configured to
execute the scan operation of dynamically changing a reflection direction of the radio wave reflective plate in response to receiving the request light projected from the first optical communication machine associated with the communication device, and
the first optical communication machine is configured to
acquire, in response to receiving a response signal by the phased array antenna to the radio wave transmitted from the communication target during a period of the scan operation, information about the communication target included in the response signal,
project information light including the acquired information about the communication target toward the second optical communication machine associated with the reflection device, and
set a reflection direction of the radio wave reflective plate in response to receiving the information light projected from the first optical communication machine associated with the communication device in such a way as to conform to communication between the communication device and the communication target.

7. The communication system according to claim 1, wherein
the plurality of communication devices is configured to share the radio wave reflective plate of the reflection device.

8. The communication system according to claim 1, wherein
the plurality of the communication devices is configured to
be connected to each other in a cooperative manner through a network, and
communicate with a communication target with which each of the plurality of communication devices is to communicate using the plurality of reflection devices.

9. A communication method executed by a computer in a communication system including a phased array antenna that transmits a beamformed radio wave and a radio wave reflective plate having a reflection surface of a meta-surface structure, the communication method comprising:
causing a first optical communication machine associated with the phased array antenna to project projection light toward a second optical communication machine associated with the radio wave reflective plate;
causing the second optical communication machine that is activate in response to receiving the projection light projected from the first optical communication machine to generate direction data in response to detecting a direction from which the projection light arrives;
causing the second optical communication machine to retroreflect reflected light of the projection light modulated in a pattern according to transmission data including device data related to the radio wave reflective plate and the direction data toward the first optical communication machine;
causing the first optical communication machine to acquire the transmission data related to the radio wave reflective plate according to a pattern of the reflected light from the second optical communication machine; and
causing the first optical communication machine to control the phased array antenna according to the device data acquired by the first optical communication machine.

10. A non-transitory recording medium storing a program for operating a communication system including a phased array antenna that transmits a beamformed radio wave and a radio wave reflective plate having a reflection surface of a meta-surface structure, the program causing a computer to execute the steps of:
causing a first optical communication machine associated with the phased array antenna to project projection light toward a second optical communication machine associated with the radio wave reflective plate;
causing the second optical communication machine that is activated in response to receiving the projection light projected from the first optical communication machine to generate direction data in response to detecting a direction from which the projection light arrives;
causing the second optical communication machine to retroreflect reflected light of the projection light modulated in a pattern according to transmission data including device data related to the radio wave reflective plate and the direction data toward the first optical communication machine;
causing the first optical communication machine to acquire the transmission data related to the radio wave reflective plate according to a pattern of the reflected light from the second optical communication machine; and
causing the first optical communication machine to control the phased array antenna according to the device data acquired by the first optical communication machine.

11. The communication method according to claim 9, wherein
the first optical communication machine includes a projector that projects the projection light, a light receiver that receives the reflected light from the second optical communication machine and generates digital data related to a pattern of the received reflected light, and a controller, and wherein
causing the controller to cause the projector to project the projection light, acquire the transmission data related to the radio wave reflective plate from the digital data generated by the light receiver, and cause the phased array antenna to transmit the radio wave toward the radio wave reflective plate according to the acquired transmission data.

12. The communication method according to claim 9, wherein
the second optical communication machine includes a storage circuit that stores the device data related to the associated radio wave reflective plate, a photovoltaic generator that generates power in response to receiving the projection light, a direction sensor that detects a direction from which the projection light arrives and stores the direction data related to the detected direction in the storage circuit, a reflector including a retroreflective plate including a reflection surface that retroreflects the projection light and a shutter that is opened and closed by electrical control, and a drive circuit, and wherein
causing the drive circuit to generate transmission data including the device data and the direction data that are stored in the storage circuit, and open and close the shutter in a pattern according to the generated transmission data.

13. The communication method according to claim 12, wherein
causing the first optical communication machine to project the projection light modulated in a pattern of a constant cycle, and
causing the second optical communication machine to open and close the shutter in a pattern according to the transmission data to reflect the reflected light modulated in the pattern according to the transmission data.

14. The communication method according to claim 9, wherein
a reflection direction of the radio wave reflective plate is dynamically controlled according to control of the second optical communication machine, and wherein
causing the first optical communication machine to
project request light for requesting a scan operation for dynamically changing a reflection direction of the radio wave reflective plate in response to receiving the reflected light toward the second optical communication machine associated with the reflection device, and
transmit, from the phased array antenna, a radio signal for scanning a communication target with which the communication device is to communicate,
causing the second optical communication machine to
execute the scan operation of dynamically changing a reflection direction of the radio wave reflective plate in response to receiving the request light projected from the first optical communication machine associated with the communication device, and
causing the first optical communication machine is configured to
acquire, in response to receiving a response signal by the phased array antenna to the radio wave transmitted from the communication target during a period of the scan operation, information about the communication target included in the response signal,
project information light including the acquired information about the communication target toward the second optical communication machine associated with the reflection device, and
set a reflection direction of the radio wave reflective plate in response to receiving the information light projected from the first optical communication machine associated with the communication device in such a way as to conform to communication between the communication device and the communication target.

15. The communication method according to claim 9, wherein
the plurality of communication devices is configured to share the radio wave reflective plate of the reflection device.

16. The communication method according to claim 9, wherein
the plurality of the communication devices is configured to be connected to each other in a cooperative manner through a network, and wherein
causing he plurality of the communication devices to communicate with a communication target with which each of the plurality of communication devices is to communicate using the plurality of reflection devices.
